(19) United States
(12) Patent Application Publication
(10) Pub. No.: US 2019/0219678 A1
(43) Pub. Date: Jul. 18, 2019

(54) RECEIVED SIGNAL STRENGTH MEASURING APPARATUS, RECEIVED SIGNAL STRENGTH MEASURING METHOD, RECORDING MEDIUM, AND KEYLESS ENTRY SYSTEM

(71) Applicant: ALPS ALPINE CO., LTD., Tokyo (JP)

(72) Inventor: Akira MIYAZAWA, Miyagi (JP)

(21) Appl. No.: 16/366,206

(22) Filed: Mar. 27, 2019

Related U.S. Application Data
(63) Continuation of application No. PCT/JP2017/034322, filed on Sep. 22, 2017.

(30) Foreign Application Priority Data
Oct. 14, 2016 (JP) 2016-202942

(51) Int. Cl. G01S 11/06; H04B 17/318; B60R 25/24

(52) U.S. Cl. CPC G01S 11/06; B60R 25/24; H04B 17/318

(57) ABSTRACT

A signal strength obtaining unit obtains, first received signal strengths at a receiver over a first period of time in which a target signal is transmitted, and obtains second signal strengths at the receiver over a second period of time in which the target signal is not transmitted. A signal strength calculating unit calculates a signal strength of the received target signal by using a first method based on an assumption that a noise signal whose amplitude changes is superimposed on the target signal when a variance value of the second signal strengths exceeds a first threshold, and calculates the signal strength of the received target signal by using a second method based on an assumption that a noise signal whose amplitude is constant is superimposed on the target signal when the variance value of the second signal strengths is less than or equal to the first threshold.

### CROSS-REFERENCE TO RELATED APPLICATIONS

This application is a continuation of International Application No. PCT/JP2017/034322 filed on Sep. 22, 2017 and designating the U.S., which claims priority to Japanese Patent Application No. 2016-202942 filed on Oct. 14, 2016. The contents of these applications are incorporated herein by reference in their entirety.

### BACKGROUND OF THE INVENTION

### 1. Field of the Invention

The disclosures herein generally relate to an apparatus for measuring a signal strength of a received radio signal, and specifically relate to an apparatus for measuring a signal strength of a received radio signal in order to calculate a distance between a vehicle and a portable device in, for example, a keyless entry system.

### 2. Description of the Related Art

Conventionally, keyless entry systems that perform vehicle operations, such as locking and unlocking the doors and starting the engine of a vehicle based on radio communication between a vehicle-side device and a portable device, are known. In general, the vehicle-side device transmits a radio signal of a low-frequency (LF) band (LF radio signal) from each of a plurality of antennas provided on the vehicle. The portable device calculates a distance from each of the antennas based on a signal strength of a received radio signal transmitted from each of the antennas, and transmits distance information to the vehicle-side device through a radio signal of a radio-frequency band (an RF radio signal). The vehicle-side device identifies the position of the portable device based on the distance information obtained from the portable device, and controls the locking and unlocking of the doors of the vehicle based on the identified position. For example, when the portable device is inside the vehicle, the vehicle-side device disables an automatic door locking function to prevent the portable device from being locked inside the vehicle.

However, when a keyless entry system is used in places susceptible to noise, such as a large parking lot where a large number of vehicles are parked and a construction site where various electrical apparatuses are operated, a measurement result of the received signal strength may be affected by noise, making it difficult to accurately measure a distance.

In an apparatus disclosed in Patent Document 1, a ratio of a signal strength of a combined signal to a signal strength of a second signal is calculated. The combined signal contains a first signal (a signal used for distance measurement) and the second signal (a noise signal transmitted from other equipment). Then, a coefficient associated with a value of the calculated ratio is read from storage, and the coefficient is applied to the signal strength of the combined signal that contains the first signal and the second signal. As a result, a signal strength of the first signal is calculated. Accordingly, even if noise (a second signal) exists, a signal strength can be accurately measured.

In the above-described apparatus disclosed in Patent Document 1, when a beat occurs in a combined signal of first and second signals whose amplitude is constant and frequencies are different, a signal strength of the first signal is calculated based on a signal strength of the combined signal and on a signal strength of the second signal. Thus, when the amplitude of the noise signal changes, it is difficult for the apparatus disclosed in Patent Document 1 to accurately calculate a received signal strength.

### Related-Art Documents

### Patent Documents

Patent Document 1 Japanese Laid-Open Patent Publication No. 2011-188413

### SUMMARY OF THE INVENTION

It is a general object of one aspect of the present invention to provide a received signal strength measuring apparatus, a received signal strength measuring method, a non-transitory recording medium, and a keyless entry system that includes the received signal strength measuring apparatus, in which a strength of a received signal can be accurately measured even when a noise signal whose amplitude changes is superimposed on the signal.

According to at least one embodiment, a received signal strength measuring apparatus for measurement of a signal strength of a received target signal is provided. The received signal strength measuring apparatus includes a receiver configured to receive one or more wireless signals; a signal strength obtaining unit configured to obtain, as a plurality of first signal strengths, a plurality of received signal strengths at the receiver over a first period of time in which the target signal whose frequency and amplitude are constant is transmitted, and to obtain, as a plurality of second signal strengths, a plurality of received signal strengths at the receiver over a second period of time in which the target signal is not transmitted; and a signal strength calculating unit configured to calculate a signal strength of the received target signal, based on the plurality of first signal strengths obtained over the first period of time and on the plurality of second signal strengths obtained over the second period of time. The signal strength calculating unit is configured to calculate the signal strength of the received target signal by using a first calculation method when a variance value of the plurality of second signal strengths exceeds a first threshold, the first calculation method being based on an assumption that a noise signal whose amplitude changes is superimposed on the received target signal, and calculate the signal strength of the received target signal by using a second calculation method when the variance value of the plurality of second signal strengths is less than or equal to the first threshold, the second calculation method being based on an assumption that a noise signal whose amplitude is constant is superimposed on the received target signal.

According to at least one embodiment, a received signal strength measuring method for measuring a signal strength of a received target signal is provided. The received signal strength measuring method includes receiving one or more wireless signals at a receiver; obtaining, as a plurality of first signal strengths, a plurality of received signal strengths at the receiver over a first period of time in which the target signal whose frequency and amplitude are constant is transmitted; obtaining, as a plurality of second signal strengths, a plurality of received signal strengths at the receiver over a second period of time in which the target signal is not transmitted; and calculating a signal strength of the received target signal, based on the plurality of first signal strengths obtained over the first period of time and on the plurality of second signal strengths obtained over the second period of time. The calculating includes calculating the signal strength of the received target signal by using a first calculation method when a variance value of the plurality of second signal strengths exceeds a first threshold, the first calculation method being based on an assumption that a noise signal whose amplitude changes is superimposed on the received target signal, and calculating the signal strength of the received target signal by using a second calculation method when the variance value of the plurality of second signal strengths is less than or equal to the first threshold, the second calculation method being based on an assumption that a noise signal whose amplitude is constant is superimposed on the received target signal.

Other objects and further features of the present invention will be apparent from the following detailed description when read in conjunction with the accompanying drawings.

### BRIEF DESCRIPTION OF THE DRAWINGS

FIG. 1 is a diagram illustrating a configuration of a keyless entry system according to an embodiment, in which a configuration of a vehicle-side device is mainly illustrated;

FIG. 2 is a diagram illustrating an installation example of installation locations of antennas in a vehicle;

FIG. 3 is a diagram illustrating an example of a configuration of the keyless entry system, in which a configuration of a portable device is mainly illustrated;

FIGS. 4A and 4B are diagrams illustrating examples of LF signals received by the portable device and an RF signal transmitted from the portable device; in which FIG. 4A illustrates the LF signals and FIG. 4B illustrates the RF signal;

FIGS. 5A through 5F are graphs illustrating combined signals of noise signals and target signals;

FIGS. 6A through 6D are graphs illustrating combined signals of noise signals and target signals;

FIG. 7A is a graph illustrating an example for calculating a signal strength of a received target signal by using a second calculation method;

FIG. 7B is a table illustrating an example for calculating the signal strength of the received target signal by using the second calculation method;

FIG. 7C is a table illustrating an example for calculating the signal strength of the received target signal by using the second calculation method;

FIG. 8 is a flowchart illustrating an example of a process for transmitting a response signal in response to a request signal in the portable device;

FIG. 9 is a first flowchart illustrating an example of a process for calculating a signal strength of a received target signal in the portable device;

FIG. 10 is a second flowchart illustrating an example of a process for calculating the received signal strength the target signal in the portable device;

FIG. 11 is a flowchart illustrating an example of a process of a second calculation method;

FIG. 12A is a flowchart illustrating an example of a process of a first calculation method;

FIG. 12B is a flowchart illustrating an example of a process of a first calculation method; and

FIG. 13 is a flowchart illustrating one variation of a calculation process of received signal strength.

### DESCRIPTION OF THE PREFERRED EMBODIMENTS

According to at least one embodiment, a signal strength of a received target signal can be accurately measured even when a noise signal with varying amplitude is superimposed on the measurement signal.

In the following, embodiments of the present invention will be described with reference to the accompanying drawings.

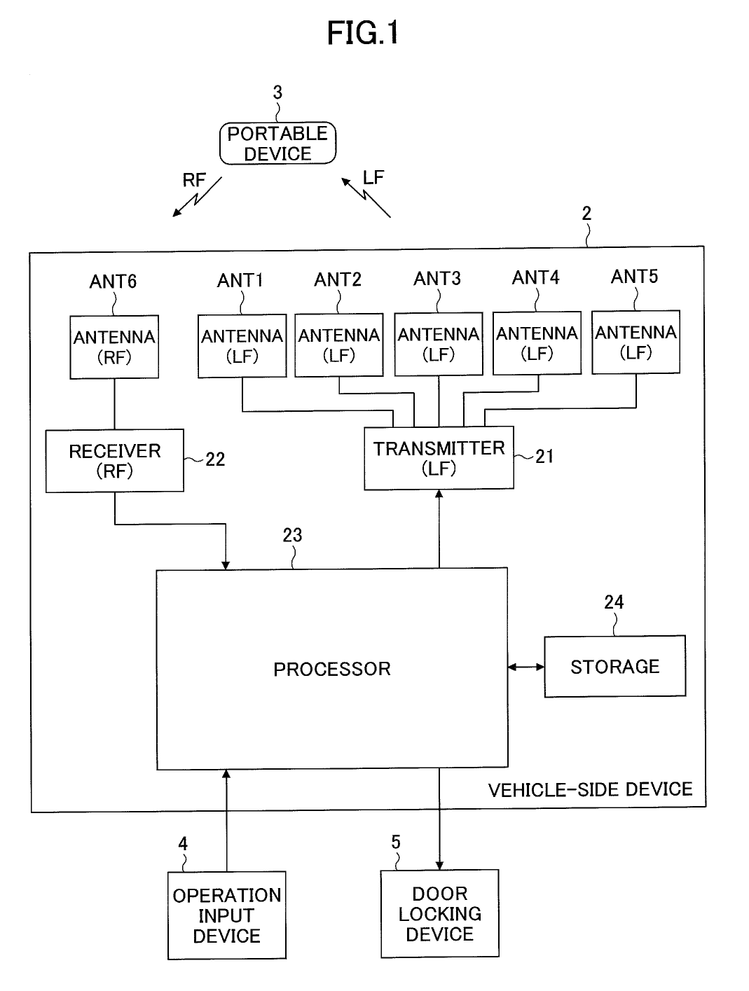

FIG. 1 is a diagram illustrating a configuration of a keyless entry system according to an embodiment. The keyless entry system illustrated in FIG. 1 includes a vehicle-side device 2 mounted on a vehicle 1 and a portable device 3 that can be carried by a user.

The keyless entry system illustrated in FIG. 1 generally operates as follows. When the user having the portable device 3 operates an operation input device 4 (such as a door opening/closing button and an engine start button), the vehicle-side device 2 of the vehicle 1 transmits a request signal Rq of a low-frequency band (LF band) to the portable device 3. When the request signal Rq is received by the portable device 3, a response signal An of an RF band is transmitted from the portable device 3 to the vehicle-side device 2. Based on the response signal An received from the portable device 3, the vehicle-side device 2 performs an authentication process for determining whether the portable device 3 is preliminarily registered. When the portable device 3 is preliminarily registered, predetermined vehicle control (such as unlocking of the doors) is performed in the vehicle 1 in accordance with the operation of the operation input device 4.

As illustrated in FIG. 1, the vehicle-side device 2 includes a transmitter 21, antennas ANT1 through ANT5 connected to the transmitter 21, a receiver 22, an antenna ANT 6 connected to the receiver 22, a processor 23, and a storage 24.

The transmitter 21 transmits a radio signal of the LF band (a LF radio signal) to the portable device 3. In other words, the transmitter 21 generates a LF radio signal by performing a predetermined signal process including encoding, modulation, and amplification on transmission data generated by the processor 23, and transmits the generated signal as a radio signal from the antennas ANT1 through ANT5. In this case, the transmitter 21 selects one of the antennas ANT1 through ANT5 in accordance with control of the processor 23, and transmits the radio signal from the selected antenna.

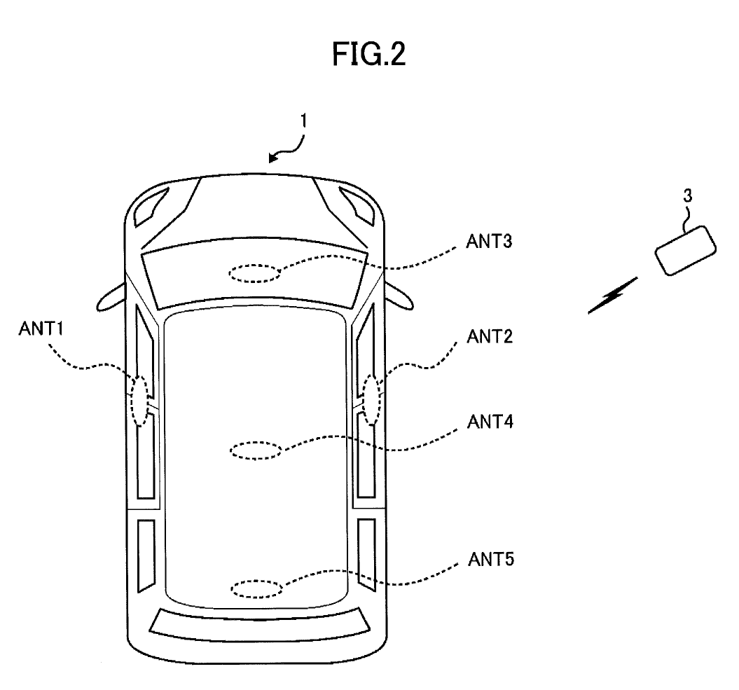

FIG. 2 is a diagram illustrating an example of installation locations of the antennas ANT1 through ANT5 in the vehicle 1. In the example of FIG. 2, the antenna ANT1 is installed near the left-side doors, the antenna ANT2 is installed near the right-side doors, the antenna ANT3 is installed at the front inside the vehicle, the antenna ANT4 is installed at the center inside the vehicle, and the antenna ANT5 is installed at the rear inside the vehicle. In the following description, the antennas ANT1 through ANT5 may be collectively referred to as an “antenna ANT” without being distinguished from one another.

The receiver 22 receives a RF radio signal transmitted from the portable device 3. In other words, the receiver 22 generates reception data by performing a predetermined signal process such as amplification, demodulation, and decoding on the RF radio signal received at the antenna ANT 6, and outputs the reception data to the processor 23.

The processor 23 is a circuit that performs the overall process of the vehicle-side device 2. The processor 23 includes, for example, a computer (such as a microprocessor) that executes commands based on a program stored in the storage 24, and a dedicated logic circuit (such as an application-specific integrated circuit: ASIC), for example.

When a user's operation for giving an instruction to unlock or lock the doors is input to the operation input device 4, the processor 23 performs radio communication with the portable device 3 by using the transmitter 21 and the receiver 22.

In the radio communication, the processor 23 first performs a transmission process for causing the transmitter 21 to transmit a LF request signal Rq that requests a response from the portable device 3. In this case, the processor 23 selects and uses one of the antennas ANT1 through ANT5 to transmit the request signal.

Further, following the transmission process for the request signal Rq, the processor 23 also performs a process for causing the transmitter 21 to transmit a target signal S of a constant frequency and constant amplitude. The processor 23 selects one of the antennas ANT1 through ANT5 in a predetermined order, and transmits the target signal S from the selected antenna. The target signal S is a signal whose received signal strength at the portable device 3 is measured, and is used to determine the position of the portable device 3. In the portable device 3, received signal strengths of target signals S transmitted from the antennas ANT1 through ANT5 are measured, and distances from the respective antennas ANT1 through ANT5 are calculated based on measurement results.

After the process for transmitting the request signal Rq, the processor 23 waits until receiving a response signal An from the portable device 3 in response to the request signal Rq. The response signal An includes authentication information indicating that the portable device 3 is a valid transmission source, and also includes distance information on the distances of the respective antennas (ANT1 through ANT5). Upon the receiver 22 receiving the response signal An from the portable device 3, the processor 23 performs the authentication process for determining whether the portable device 3 is a valid transmission source, based on the authentication information included in the received response signal An. Further, based on the distance information included in the response signal An, the processor 23 performs a position determination process for determining the position of the portable device 3 with respect to the vehicle 1. For example, the processor 23 determines whether the portable device 3 is located inside the vehicle or outside the vehicle 1, or located within a predetermined vicinity range of the vehicle 1.

When the processor 23 determines that the portable device 3 is a valid transmission source, the processor 23 performs vehicle control in accordance with the operation of the operation input device 4 if the position of the portable device 3 satisfies a predetermined condition. For example, when an operation for unlocking the doors is performed in the operation input device 4, the processor 23 outputs a control signal for unlocking the doors to a door locking device 5 in response to the processor 23's determination that the portable device 3 is located within the predetermined vicinity range of the vehicle 1. Furthermore, when an operation for locking the doors is performed in the operation input device 4, the processor 23 outputs a control signal for locking the doors to the door locking device 5 in response to the processor 23's determination that the portable device 3 is located outside the vehicle 1.

The storage 24 is a device that stores, for example, a program for a computer in the processor 23, data preliminarily prepared for processing, and data temporarily stored during processing. The storage 24 includes random-access memory (RAM), non-volatile memory, and a hard disk. The program and the data stored in the storage 24 may be downloaded from an upper-level device via an interface device (not illustrated), or may be read from a non-transitory recording medium recording medium such as an optical disc or a USB memory.

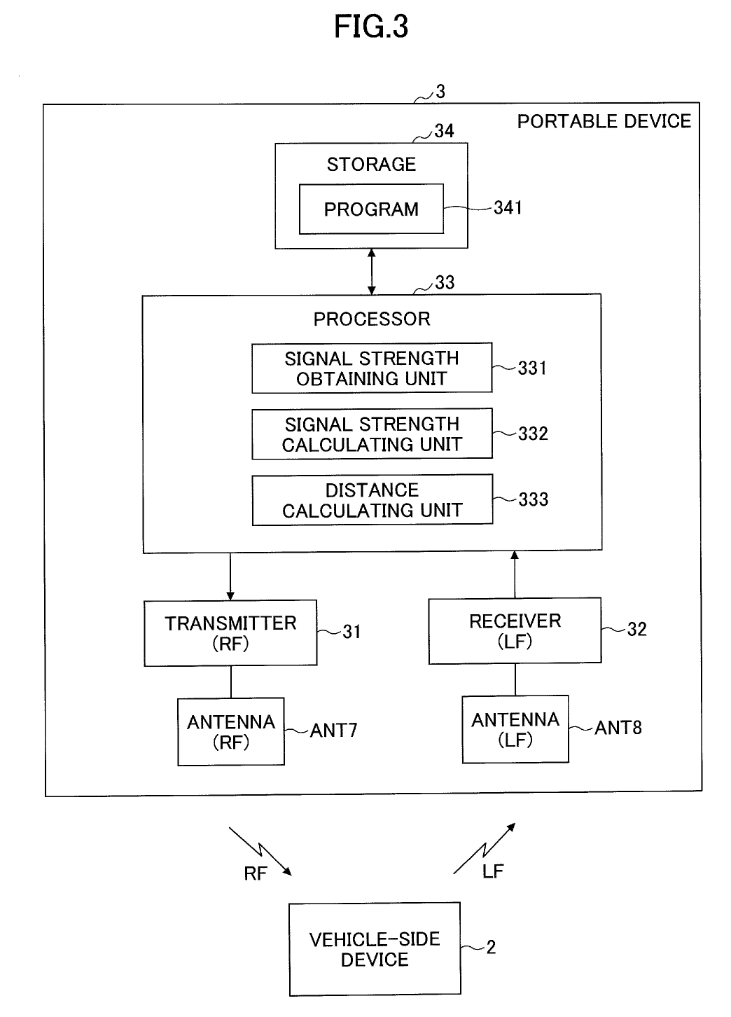

FIG. 3 is a diagram illustrating an example of a configuration of the portable device 3. The portable device 3 illustrated in FIG. 3 includes a transmitter 31, an antenna ANT7 connected to the transmitter 31, a receiver 32, an antenna ANT8 connected to the receiver 32, a processor 33, and a storage 34.

The transmitter 31 transmits an RF radio signal to the vehicle-side device 2. In other words, the transmitter 31 generates an RF radio signal by performing a predetermined signal process including encoding, modulation, and amplification on transmission data generated by the processor 23, and transmits the generated signal from the antenna ANT7 as a radio signal.

The receiver 32 receives a LF radio signal transmitted from the vehicle-side device 2. In other words, the receiver 32 generates reception data by performing a predetermined signal process including amplification, demodulation, and decoding on the LF radio signal received at the antenna ANT 8, and outputs the generated reception data to the processor 33.

The processor 33 is a circuit that performs the overall process of the portable device 3. The processor 33 includes, for example, a computer (such as a microprocessor) that executes commands based on a program 341 stored in the storage 34, and a dedicated logic circuit (such as ASIC), for example.

When the receiver 32 receives the above-described request signal Rq, the processor 33 generates authentication information to be used in an authentication process performed by the vehicle-side device 2, based on identification information of the vehicle 1 included in the request signal Rq and information (such as identification information and a rolling code) of the portable device 3 stored in the storage 34.

Further, following the request signal Rq, the receiver 32 receives target signals sequentially transmitted from the antennas ANT in the predetermined order, and also receives noise signals for periods of time during which the target signals S are not transmitted. Based on a reception result, the processor 33 calculates signal strengths of the received target signals S transmitted from the antennas ANT.

Further, based on the signal strength of the received target signal S transmitted from each of the antennas ANT, the processor 33 calculates a distance from each of the antennas ANT. For example, the storage 34 may preliminarily store a data table in which a signal strength of the received target signal S is associated with a distance from an antenna ANT. Based on this data table, the storage 34 obtains a distance associated with a calculation result of the signal strength of the received target signal S. It should be noted that an omnidirectional antenna such as a three-axis antenna is used as the antenna ANT8, such that a relationship between a received signal strength and a distance is maintained constant, independent of the direction and orientation of the portable device 3.

The processor 33 causes the transmitter 31 to transmit, to the vehicle-side device 2, a response signal An that includes distance information indicating the distance from each of the antennas ANT and the above-described authentication information.

The processor 33 includes a signal strength obtaining unit 331, a signal strength calculating unit 332, and a distance calculating unit 333, as processing blocks related to measurement of a signal strength of the received target signal S transmitted from each of the antennas ANT and calculation of a distance from each of the antennas ANT. The receiver 32, the signal strength obtaining unit 331, and the signal strength calculating unit 332 of the portable device 3 correspond to a received signal strength measuring apparatus according to the embodiments of the present invention.

### Signal Strength Obtaining Unit 331

The signal strength obtaining unit 331 obtains, as “first signal strengths K”, received signal strengths at the receiver 32 for a period of time in which a target signal S is transmitted from an antenna ANT of the vehicle-side device 2 (hereinafter referred to as a “first period of time TA”). Further, the signal strength obtaining unit 33 obtains, as “second signal strengths N”, received signal strengths at the receiver 32 for a period of time in which the target signal S is not transmitted from the antenna ANT of the vehicle-side device 2 (hereinafter referred to as a “second period of time TB”).

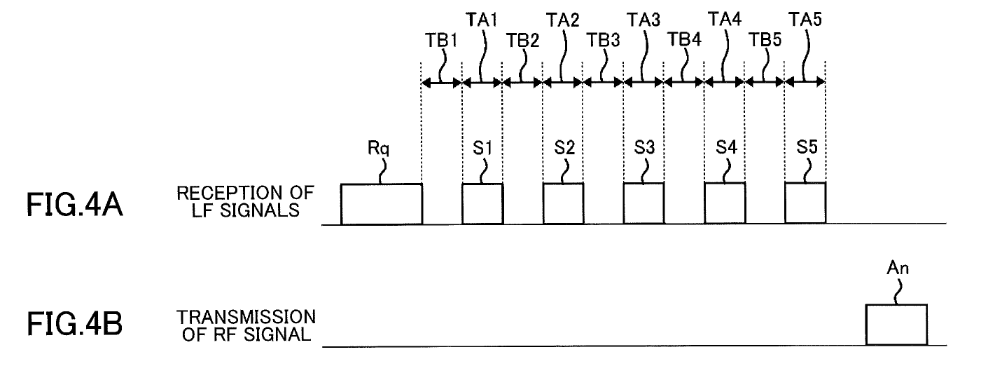

FIGS. 4A and 4B are diagrams illustrating examples of LF signals received at the portable device 3 and an RF signal transmitted from the portable device 3. FIG. 4A illustrates the LF signals and FIG. 4B illustrates the RF signal. “S1” through “S5” illustrated in FIG. 4A indicate target signals S transmitted from different antennas ANT. “TA1” through “TA5” indicate first periods of time TA of the respective target signals S1 through S5 (periods of time in which the LF signals are transmitted). Further, “TB1” through “TB5” indicate second periods of time TB of the respective target signals S1 through S5 (periods of time in which the LF signals are not transmitted).

In the example of FIG. 4A, a second period of time TBi of a target signal Si (i represents an integer from 1 to 5) comes immediately before a corresponding first period of time TAi; however, the present invention is not limited to this example. The second period of time TBi may be a period of time immediately after a corresponding first period of time TAi. Preferably, the second period of time TBi is a period of time immediately before a corresponding first period of time TAi.

Timings at which to transmit the request signal Rq and the target signals S1 through S5 from the vehicle-side device 2 are predetermined. Accordingly, when the receiver 32 receives the request signal Rq, the first periods of time TA1 through TA5 and the second periods of time TB1 through TB5 are determined based on the timing at which the request signal Rq is received. The signal strength obtaining unit 331 obtains a received signal strength at the receiver 32 for each of the first periods of time TA1 through TA5 and for each of the second periods of time TB1 through TB5, which are determined based on the timing at which the request signal Rq is received. The signal strength obtaining unit 331 stores, as first signal strengths K, received signal strengths obtained over a first period of time TAi in the storage 34, and stores, as second signal strengths N, received signal strengths obtained over a second period of time TBi in the storage 34.

### Signal Strength Calculating Unit 332

The signal strength calculating unit 332 calculates signal strengths of the received target signals S transmitted from the plurality of respective antennas ANT of the vehicle-side device 2. To be more specific, the signal strength calculating unit 332 calculates a signal strength of a received target signal Si, based on a plurality of first signal strengths K obtained for a first period of time TAi and on a plurality of second signal strengths N obtained for a second period of time TBi.

The second signal strengths N obtained over the second period of time TB in which the target signal S is not transmitted may be regarded as signal strengths of a received noise signal other than the target signal S. Further, the first signal strengths K obtained over the first period of time TA in which the target signal S is transmitted may be regarded as signal strengths of a received signal in which the target signal S and the noise signal are combined. The signal strength calculating unit 332 selects an appropriate calculation method in accordance with characteristics of the noise signal indicated by the second signal strengths N, and uses the selected calculation method to calculate the signal strength of the received target signal S based on the first signal strengths K and the second signal strengths N.

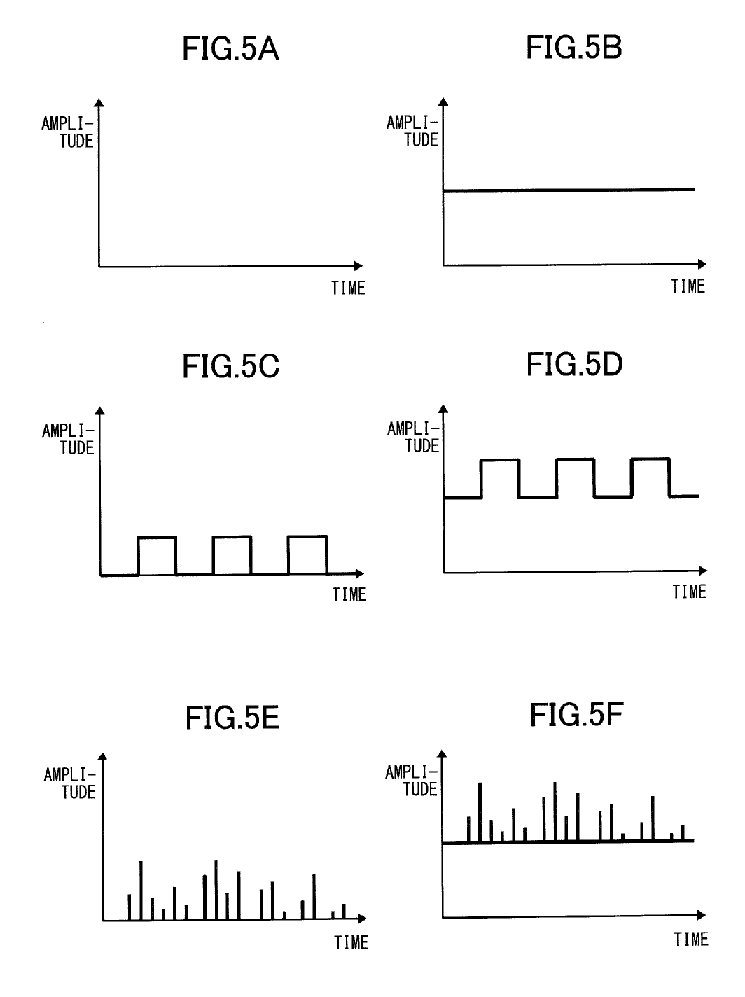

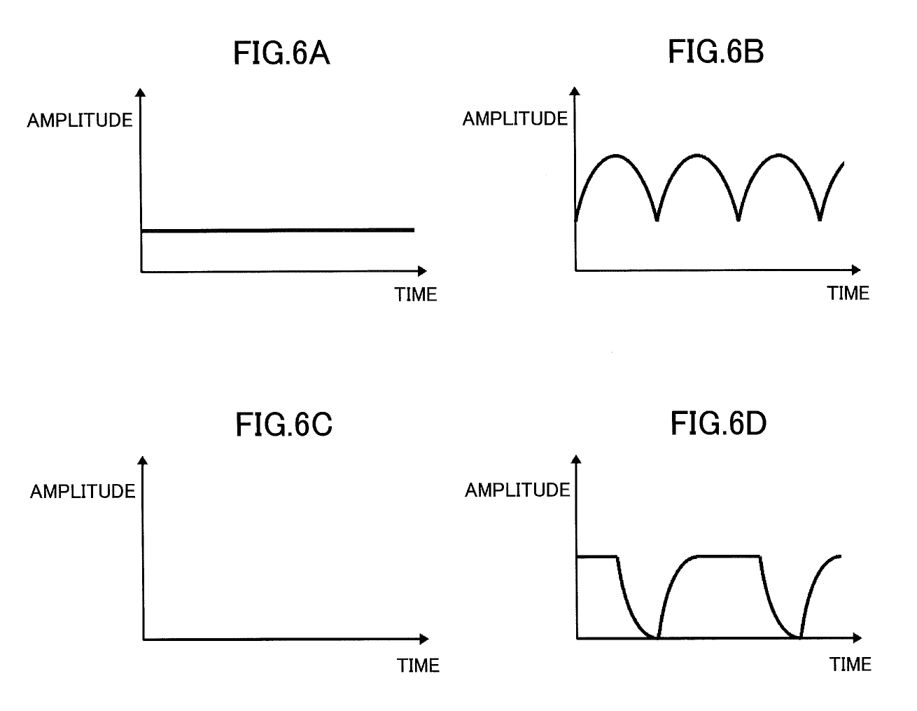

FIGS. 5A through 5F and FIGS. 6A through 6D are graphs illustrating combined signals of noise signals and target signals S. FIGS. 5A, 5C, 5E, 6A, and 6C at the left indicate waveforms of the noise signals and FIGS. 5B, 5D, 5F, 6B, and 6D at the right indicate waveforms of the combined signals. However, for relatively high frequency components near the frequency of the target signals S, waveforms are represented by envelopes of peaks for simplification of illustration. In FIGS. 5A through 5F and FIGS. 6A through 6D, the waveforms of the noise signals (the waveforms at the left) correspond to the second signal strengths N, and the waveforms of the combined signal (the waveforms at the right) correspond to the first signal strengths K. FIGS. 5A and 5B indicate that the noise signal is approximately zero. FIGS. 5C and 5D indicate that the amplitude of the noise signal changes periodically. FIGS. 5E and 5F indicate that the amplitude of the noise signal changes non-periodically. FIGS. 6A and 6B indicate that the amplitude of the noise signal is constant. FIGS. 6C and 6D indicate that the amplitude of the combined signal changes, even though the noise signal is very small. The signal strength calculating unit 332 switches a method for calculating a received signal strength in accordance with characteristics of a noise signal, as illustrated in FIGS. 5A through 5F and FIGS. 6A through 6D.

First, in order to measure the magnitude of a noise signal, the signal strength calculating unit 332 calculates an average value Na of second signal strengths N obtained over a second period of time TB. The signal strength calculating unit 332 compares the calculated average value Na of the second signal strengths N to a threshold Nth. The signal strength calculating unit 332 performs different processes, depending on when the average value Na exceeds the threshold Nth and when the average value Na is less than or equal to the threshold Nth. In the following, the processes performed by the signal strength calculating unit 332 when the average value Na exceeds the threshold Nth and when the average value Na is less than or equal to the threshold Nth will be described.

### <1>When Average Value Na of Second Signal Strengths N Exceeds Threshold Nth

When signal strengths of the received noise signal are relatively large, the average value Na of the second signal strengths N exceeds the threshold Nth. In this case, the signal strength calculating unit 332 selects a calculation method based on a variance value Vn of the second signal strengths N. The threshold Nth corresponds to a second threshold according to the embodiments of the present invention.

### 1-1. When Variance Value Vn of Second Signal Strength N Exceeds Threshold Vth

When changes in the signal strengths of the received noise signal are relatively large, the variance value Vn of the second signal strengths N exceeds the threshold Vth. In this case, the signal strength calculating unit 332 calculates a signal strength of a received target signal S by using a first calculation method based on an assumption that a noise signal whose amplitude changes (as illustrated in FIG. 5C and FIG. 5E) is superimposed on the target signal S. The threshold Vth corresponds to a first threshold according to the embodiments of the present invention.

1-1-1 When Second signal strengths N change Periodically

The “first calculation method” is divided into different calculation processes in accordance with whether or not the second signal strengths N changes periodically. The signal strength calculating unit 332 determines whether the second signal strengths N change periodically over the second period of time TB. When the signal strength calculating unit 332 determines that the second signal strengths N change periodically, the signal strength calculating unit 332 calculates a signal strength of the received target signal S by using a first process of the first calculation method based on an assumption that a noise signal whose amplitude changes periodically is superimposed on the target signal S (as illustrated in FIG. 5C).

For example, the signal strength calculating unit 332 identifies local maxima, with respect to second signal strengths N whose values are greater than or equal to the average value Na by a specified value or more (for example, a value that is set in accordance with the variance value Vn). Then, with respect to the identified local maxima, the signal strength calculating unit 332 defines a time interval between one local maximum and the next local maximum as one period, and calculates dispersion (a variance value, for example) with respect to the periods. When the dispersion is less than a predetermined value, the signal strength calculating unit 332 determines that the second signal strengths N change periodically. In the above-described example, it should be noted that the periods are each calculated based on a time interval between local maxima; however, in another example, the periods may be each calculated based on a time interval between local minima.

In many cases, the noise signal whose amplitude changes periodically is a periodically occurring digital noise signal (as illustrated in FIG. 5C). Thus, the signal strength calculating unit 332 divides a plurality of first signal strengths K obtained over the first period of time TA into a first group of first signal strengths K that are relatively larger than a median value and a second group of first signal strengths K that are relatively smaller than the median value. The median value is determined based on a range of changes in the plurality of first signal strengths K. For example, the median value is a value obtained by adding a maximum value and a minimum value of the plurality of first signal strengths K and dividing the added value by 2. Of the two groups divided with the median value as the boundary, the signal strength calculating unit 332 calculates an average value of the first signal strengths K of the second group as the signal strength of the received target signal S. Because the first signal strengths K of the first group are likely to include a periodically occurring noise signal, the first signal strengths K of the first group are excluded from the average value calculation.

### 1-1-2 When Second Signal Strengths N Change Non-Periodically

Conversely, when the signal strength calculating unit 332 determines that the second signal strengths N change non-periodically, the signal strength calculating unit 332 calculates a signal strength of the received target signal S by using a second process of the first calculation based on an assumption that a noise signal whose amplitude changes non-periodically is superimposed on the target signal S (as illustrated in FIG. 5E).

In many cases, the noise signal whose amplitude changes non-periodically is a sporadic noise signal without periodicity (as illustrated in FIG. 5E). In this case, there is a high possibility that a noise signal is not included in relatively lower signal strength levels of a combined signal of the target signal S and a sporadic noise signal. Accordingly, the signal strength calculating unit 332 selects, from the whole of the plurality of first signal strengths K obtained over the first period of time TA, a group of relatively smaller first signal strengths K, which is equivalent to a predetermined proportion to the whole (for example, one-fourth of the whole). The signal strength calculating unit 332 calculates an average value of the selected first signal strengths K as the signal strength of the received target signal S. The rest of the plurality of first signal strengths K, which has not been selected, is likely to include a non-periodically occurring noise signal. Thus, the rest of the plurality of the first signal strengths K are excluded from the average value calculation.

1-2 When Variance Value Vn of Second Signal Strengths N is Less than or Equal to Threshold Vth

When changes in the signal strength of the received noise signal are relatively small, the variance value Vn of the second signal strength N is equal to or less than the threshold Vth. In this case, the signal strength calculating unit 332 calculates a signal strength of the received target signal S by using a “second calculation method” based on an assumption that the noise signal whose amplitude is constant (as illustrated in FIG. 6A) is superimposed on the target signal S.

In the second calculation method, the signal strength calculating unit 332 calculates a signal strength of the received target signal S based on a ratio (an average value ratio α) of an average value Kp of first signal strengths K to the average value Na of second signal strengths N. A time interval in which first signal strengths K increase or decrease from one extremum to the next extremum is considered as a “unit period of time.” In this case, the average value Kp is an average value of first signal strengths K obtained over a period of time in which one or more unit periods of time are combined. The average value Na is the average value of the plurality of second signal strengths N obtained over the second period of time TB.

In the “second calculation method”, it is assumed that the frequency and the amplitude of a noise signal are constant. Further, the frequency and the amplitude of a target signal S transmitted from each of the antenna ANT of the vehicle-side device 2 are constant. Therefore, a beat occurs in a combined signal of the target signal S with the noise signal. In other words, the amplitude of the combined signal changes in a cycle in accordance with a frequency difference between the target signal S and the noise signal (as illustrated in FIG. 6B). A “unit period of time”, in which first signal strengths K increase or decrease from one extremum to the next extremum, corresponds to a half-cycle of an amplitude change caused by the beat.

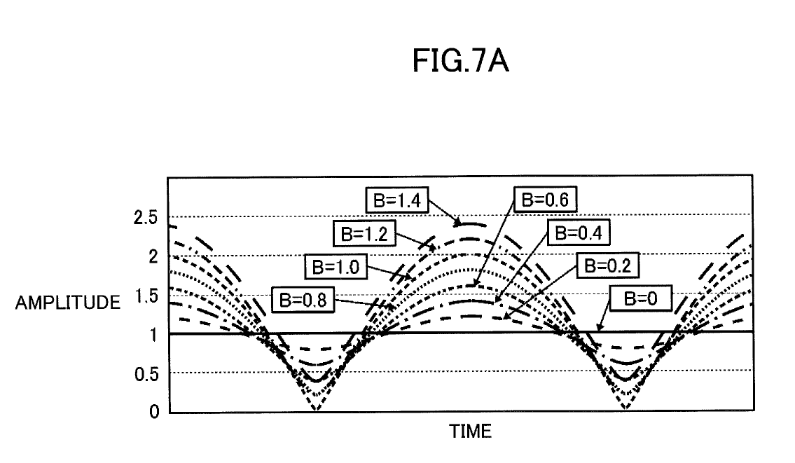

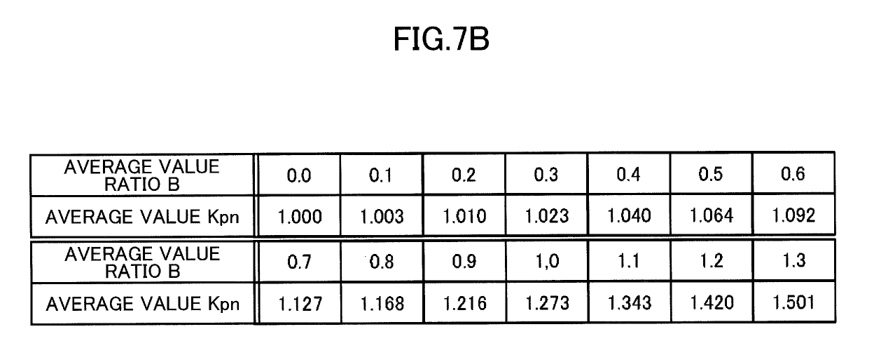

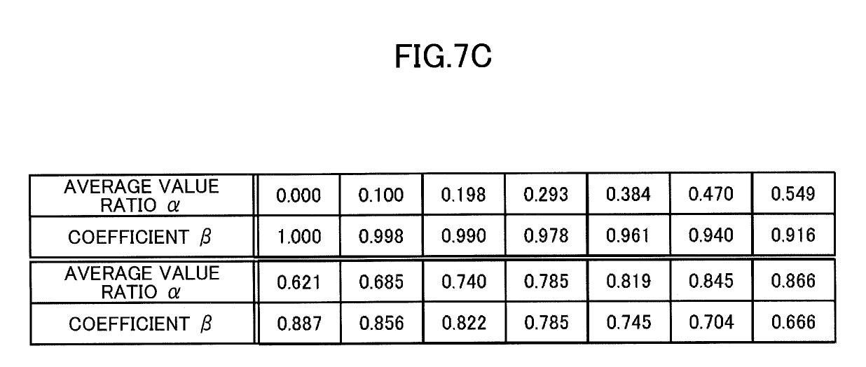

FIG. 7A is a graph illustrating an example in which the amplitude of each combined signal of a target signal S with a noise signal changes by a beat. In FIG. 7A, the vertical axis represents the amplitude of each of the combined signals, and the horizontal axis represents time. “B” in FIG. 7A represents a ratio of a signal strength of the noise signal to a signal strength of the target signal S of each of the combined signals. The ratio B is expressed by “B=N/M”, where M denotes a signal strength of a target signal S and N denotes a signal strength of a noise signal. For all the combined signals illustrated in the graph of FIG. 7A, the signal strengths M of the target signals S are 1, and the ratios B differ. As can be seen from the FIG. 7A, as the ratios B increase, the average values of the amplitude of the combined signals increase.

FIG. 7B is a diagram illustrating a relationship between a ratio B of a signal strength N of a noise signal to a signal strength M of a target signal S, versus an average value Kpn of a signal strength of each combined signal. The average value Kpn is normalized such that the signal strength M of the target signal S becomes 1. Therefore, when “Kp” represents an average value of the signal strength of the combined signal, which is not normalized, the average value Kp becomes equal to a value obtained by multiplying the signal strength M of the target signal S by the average value Kpn. Namely, the average value Kpn may be regarded as a coefficient for converting the signal strength M of the target signal S into the average value Kp of the signal strength of the combined signal.

As can be seen from FIG. 7B, as the ratio B increases (the ratio of the noise signal to the target signal S increases), the average value Kpn of each of the combined signals, in which the target signal S and the noise signal is combined, increases. The relationship between the ratio B and the average value Kpn as illustrated in FIG. 7B does not change even when the frequency of the noise signal and the frequency of the target signal S changes.

FIG. 7C is a diagram illustrating a relationship between an average value ratio α and a coefficient β. The average value ratio α represents a ratio of an average value Kp of signal strengths of a combined signal to an average value Na of signal strengths of a noise signal (α=Na/Kp). The coefficient β is a coefficient for obtaining a signal strength M of a target signal S, based on the average value Kp of the signal strengths of the combined signal. The coefficient β is a reciprocal of the average value Kpn illustrated in FIG. 7B. The correspondence relationship between the average value ratio α and the coefficient β is defined as illustrated in FIG. 7C. Therefore, by referring to the relationship illustrated in FIG. 7C, the signal strength calculating unit 332 calculates the signal strength M of the target signal S, based on the average value Kp of the signal strengths of the combined signal and on the average value Na of the signal strengths of the noise signal.

To be more specific, the signal strength calculating unit 332 calculates an average value Na of second signal strengths N, which are signal strengths of a noise signal, and also calculates an average value Kp of first signal strengths K, which are signal strengths of a combined signal. However, when calculating the average value Kp of the first signal strengths K, the signal strength calculating unit 332 identifies one or more unit periods of time (each corresponding to a half-cycle of a beat) within the first period of time TA, and calculates the average value Kp of the first signal strengths K included in the one or more unit periods of time.

After the signal strength calculating unit 332 calculates the average value Na of the second signal strengths N and the average value Kp of the first signal strengths K, the signal strength calculating unit 332 calculates an average value ratio α (=Na/Kp). Then, the signal strength calculating unit 332 obtains a coefficient β associated with the average value ratio α. For example, the storage 34 may preliminarily store a data table in which coefficients β are each associated with a corresponding average value ratio α, and the signal strength calculating unit 332 obtains a coefficient β associated with a corresponding average value ratio α by referring to the data table. It should be noted that the signal strength calculating unit 332 may perform numerical operations using an approximate function to obtain a coefficient β based on an average value ratio α.

When the coefficient β is obtained, the signal strength calculating unit 332 calculates a received signal strength (signal strength M) of the target signal S, by multiplying the average value Kp of the first signal strengths K by the obtained coefficient β.

<2>When Average Value Na of Second Signal Strengths N is Less than or Equal to Threshold Nth

When signal strengths of the received noise signal are relatively small, the average value Na of the second signal strengths N is less than or equal to the threshold Nth. In this case, the signal strength calculating unit 332 divides the plurality of first signal strengths K into two groups of a group of relatively large first signal strengths K and a group of relatively small first signal strengths K. Based on a ratio of an average value of the first group to an average value of the second group, the signal strength calculating unit 332 determines whether changes in the plurality of first signal strengths K are large.

For example, the signal strength calculating unit 332 divides the plurality of first signal strengths K obtained over the first period of time TA into a first group of first signal strengths K that are relatively larger than a median value and a second group of first signal strengths K that are relatively smaller than the median value (ST400). The median value is determined based on a range of changes in the plurality of first signal strengths K. For example, the median value is a value obtained by adding a maximum value and a minimum value of the plurality of first signal strengths K and dividing the added value by 2. Then, the signal strength calculating unit 332 calculates a ratio R of an average value Ka1 of the first group to an average value Ka2 of the second group (R=Ka1/Ka2). Based on the average value ratio R, the signal strength calculating unit 332 determines whether changes in the first signal strengths K are large. For example, when the average value ratio R is greater than or equal to a threshold Rth, the signal strength calculating unit 332 determines that the changes in the first signal strengths K are large. When the average value ratio R is less than the threshold Rth, the signal strength calculating unit 332 determines that the changes in the first signal strengths K are small.

2-1 When Changes in first signal Strengths K are Small

When the changes in the first signal strengths K are determined to be small based on the average value ratio R, the signal strength calculating unit 332 calculates a signal strength of the received target signal S by using the above-described “second calculation method”. However, in this case, the signal strength calculating unit 332 compares the average value Na of the second signal strengths N to a lower limit Nmin. When the average value Na is less than the lower limit Nmin, the signal strength calculating unit 332 calculates an average value Ka of the first signal strengths K obtained over the first period of time TA as the signal strength of the received target signal S. This is equivalent to considering the average value Na of the second signal strengths as zero.

### 2-2 When Changes in First Signal Strengths K are Large

When the changes in the first signal strengths K are determined to be large based on the average value ratio R, there may be a possibility. that the amplitude of the target signal S, which is supposed to be constant, changes (as illustrated in FIG. 6D). This indicates a likelihood that the target signal S may be spoofed through a relay attack, for example. In order to investigate this, the signal strength calculating unit 332 calculates a first variance value V1 of the first signal strengths K of the first group, which are larger than the median value, and also calculates a second variance value V2 of the first signal strengths K of the second group, which are smaller than the median value. Based on the first variance value V1, the signal strength calculating unit 332 determines whether changes in the first signal strengths K of the first group are large. Also, based on the second variance value V2, the signal strength calculating unit 332 determines whether changes in the first signal strengths K of the second group are large.

### 2-2-1 When Changes are Large in Both of Two Groups

When the changes in the first signal strengths K of both of the first group and the second group are determined to be large based on the variance values (V1 and V2), this indicates that the first signal strengths K entirely changes. Thus, the possibility of the first signal strengths K changing under the effect of a digital noise signal is low. Accordingly, in this case, the signal strength calculating unit 332 records, in the storage 34, information indicating that an unauthorized signal spoofing the target signal S (hereinafter referred to as unauthorized signal information) has been transmitted over the first period of time TA. When the unauthorized signal information is recorded in the storage 34, the signal strength calculating unit 332 does not calculate a signal strength of the received target signal S.

### 2-2-2 When Changes Are Small in One or Both of Two Groups

When the changes in the first signal strengths K of one or both of the first group and the second group are determined to be small based on the variance values (V1 and V2), the signal strength calculating unit 332 further checks the periodicity of the plurality of first signal strengths K. Namely, the signal strength calculating unit 332 determines whether the first signal strengths K of the first group, which are larger than the median value, and the first signal strengths K of the second group, which are smaller than the median value, are periodically distributed.

For example, within the first period of time TA, the signal strength calculating unit 332 identifies periods of time, in each of which a predetermined number or more of first signal strengths K of the first group are continuously present, and obtains the length of each of the identified periods of time (or the sample number of first signal strengths K, which is equivalent to the length). When dispersion (a variance value, for example) in lengths of the identified periods of time is less than a predetermined value, the signal strength calculating unit 332 determines that the first group and the second group are periodically distributed in the first period of time TA.

### 2-2-2-1 When Distribution of Two Groups is Periodic

When the first group and the second group are determined to be periodically distributed in the first period of time TA, there is a possibility that the plurality of first signal strengths K change under the effect of a digital noise signal whose amplitude changes periodically. Therefore, the signal strength calculating unit 332 calculates a signal strength of the received target signal S by using the “first process” of the “first calculation method” based on the assumption that a noise signal whose amplitude periodically changes (as illustrated in FIG. 5C) is superimposed on the target signal S.

### 2-2-2-2 When Distribution of Two Groups is Non-Periodic

When the first group and the second group are determined not to be periodically distributed in the first period of time TA, this indicates that the plurality of first signal strengths K change non-periodically. Thus, the possibility of the plurality of first signal strengths K changing under the effect of a periodic noise signal is low. Therefore, the signal strength calculating unit 332 records, in the storage 34, unauthorized signal information indicating that an unauthorized signal spoofing the target signal S has been transmitted over the first period of time TA.

### Distance calculating unit 333

Based on the signal strength of the received target signal S calculated by the signal strength calculating unit 332, the distance calculating unit 333 calculates a distance between the antenna ANT, from which the target signal S has been transmitted, and the portable device 3. The storage 34 may preliminarily store the data table in which a signal strength of the received target signal S is associated with a distance from an antenna ANT. By referring to the data table, the signal strength calculating unit 332 obtains a distance associated with a corresponding received signal strength. Alternatively, the distance calculating unit 333 may calculate a distance through numerical operations using an approximate function.

Referring back to FIG. 3, the storage 34 is a device that stores, for example, a program 341 for a computer in the processor 33, data preliminarily prepared for processing, and data temporarily stored during processing. The storage 34 includes random-access memory (RAM), non-volatile memory, and a hard disk. The program 341 and the data stored in the storage 34 may be downloaded from an upper-level device via an interface device (not illustrated), or may be read from a non-transitory recording medium such as an optical disc or a USB memory.

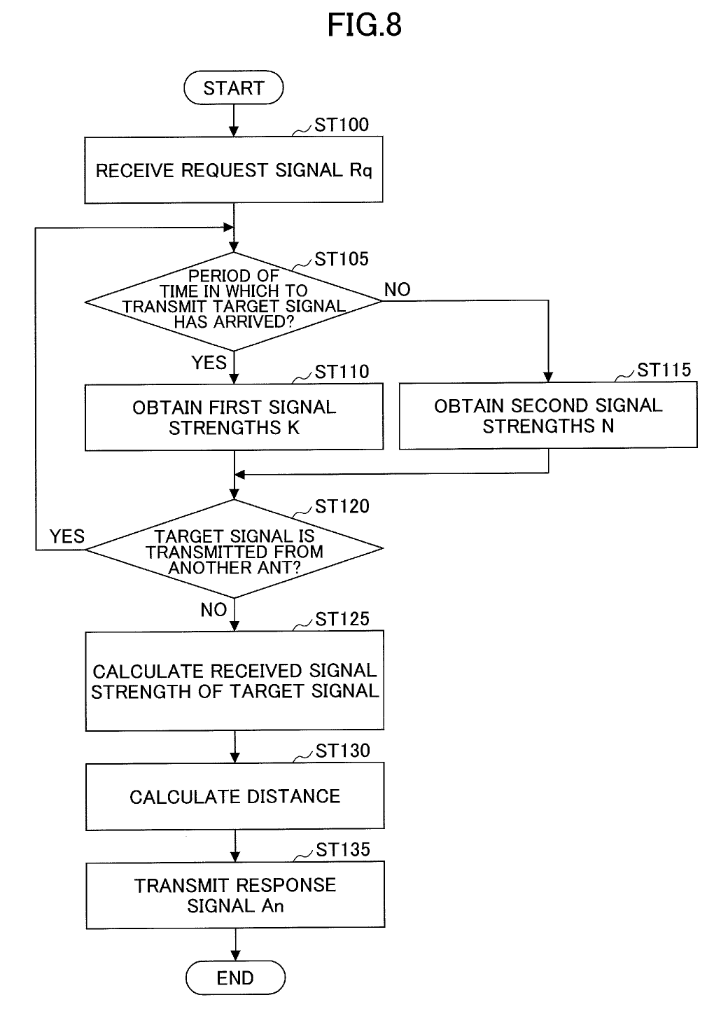

An operation of the keyless entry system with the above-described configuration according to the present embodiment will be described with reference to flowcharts illustrated in FIGS. 8 through 12B.

FIG. 8 is a flowchart illustrating an example of a process for transmitting a response signal An in response to a request signal Rq in the portable device 3.

In response to the reception of a request signal Rq, transmitted from the vehicle-side device 2, at the receiver 32 (ST100), the signal strength obtaining unit 331 determines whether a first period of time TA in which a target signal S is transmitted from one antenna ANT has arrived (ST105). When it is determined that the first period of time TA has arrived (yes in ST105), the signal strength obtaining unit 331 obtains received signal strengths at the receiver 32 as first signal strengths K, and stores the first signal strengths K in the storage (ST110). When it is determined that a second period of time TB in which the target signal S is not transmitted (no in ST105) has arrived, the signal strength obtaining unit 331 obtains received signal strengths at the receiver 32 as second signal strengths N and stores the second signal strengths N in the storage 34 (ST115).

In response to the first signal strengths of the target signal S being obtained from one antenna ANT, the signal strength obtaining unit 331 determines whether a target signal S is transmitted from another antenna ANT (ST120). When the target signal S is determined to be transmitted from another antenna ANT (YES in ST120), the signal strength obtaining unit 331 causes the process to return to ST105 and repeats the process as described above.

In response to first signal strengths K and second signal strengths N of target signals S being obtained from all antennas ANT (no in ST120), the signal strength calculating unit 332 calculates a signal strength of each of the received target signals S (ST125).

In response to the calculation of the signal strength of each of the received target signals S by the signal strength calculating unit 332, the distance calculating unit 333 calculates a distance from each of the antennas ANT based on the calculated received signal strength (ST130). For example, the distance calculating unit 333 obtains a distance associated with a corresponding received signal strength, by referring to the data table of the storage 34 in which received signal strengths are associated with distances.

The transmitter 31 of the response signal An transmits a response signal An to the vehicle-side device 2. The response signal An includes information on the distance from each of the antennas ANT and also includes authentication information to be used in an authentication process performed by the vehicle-side device 2 (ST135).

It should be noted that when unauthorized signal information is recorded in the storage 34 by the signal strength calculating unit 332, the processor 33 causes a notification, which indicates that an unauthorized signal has been transmitted, to be included in the response signal An, and transmits the response signal An.

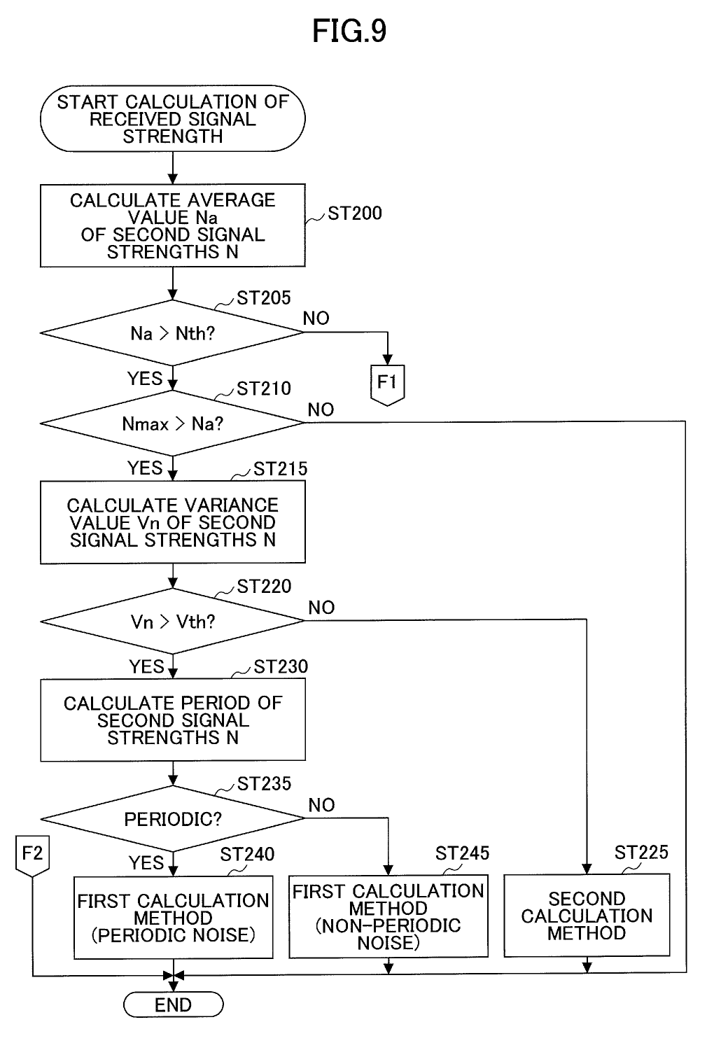

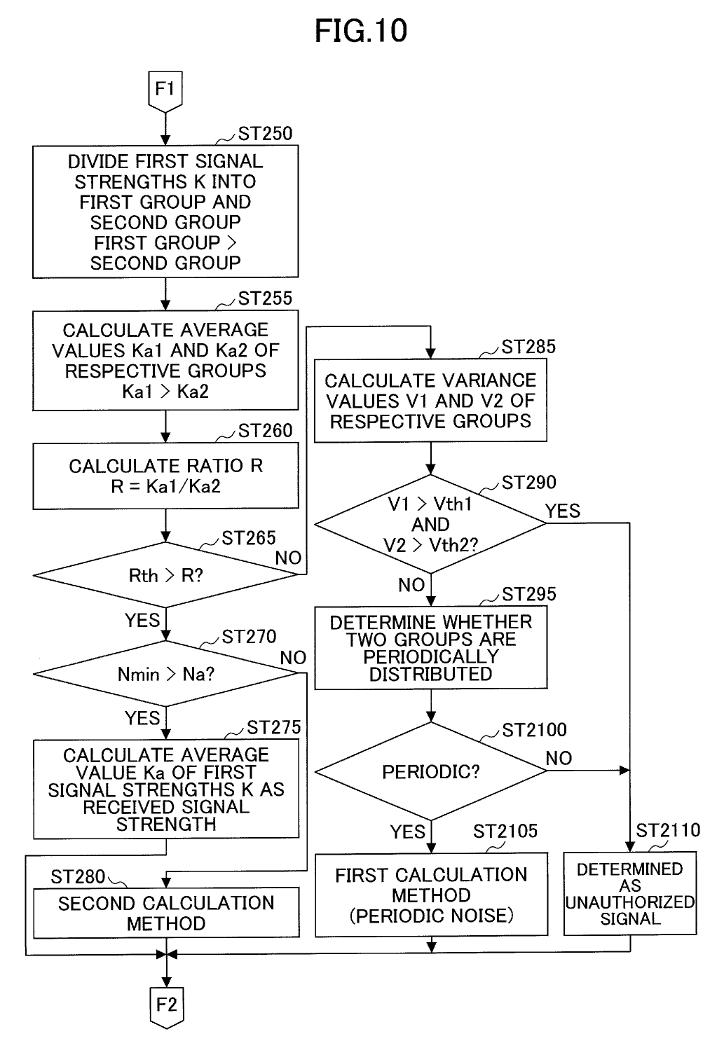

FIG. 9 and FIG. 10 are flowcharts illustrating examples of processes for calculating a signal strength of a received target signal S in the portable device 3. The processes of the flowcharts illustrated in FIG. 9 and FIG. 10 are processes performed in step ST125 of the flowchart illustrated in FIG. 8, and are performed on a per-target-signal basis.

First, the signal strength calculating unit 332 calculates an average value Na of a plurality of second signal strengths N obtained over a second period of time TB (ST200).

The signal strength calculating unit 332 compares the average value Na of the plurality of second signal strengths N to the threshold Nth (ST205). When the average value Na of the plurality of second signal strengths N exceeds the threshold Nth (yes in ST205), the signal strength calculating unit 332 further compares the average value Na of the plurality of second signal strengths N to an upper limit Nmax (ST210). When the average value Na of the second signal strengths N reaches or exceeds the upper limit Nmax (no in ST210), the signal strength calculating unit 332 ends the process without calculating the received signal strength, because an excess noise signal may result in a decrease in the calculation accuracy.

When the average value Na of the second signal strengths N is greater than the threshold Nth (yes in ST205) and is less than the upper limit Nmax (Nmax>Na>Nth) (yes in ST210), the signal strength calculating unit 332 calculates a variance value Vn of the plurality of second signal strengths N (ST215).

The signal strength calculating unit 332 compares the variance value Vn of the plurality of second signal strengths N to the threshold Vth (ST220). When the variance value Vn of the second signal strengths N is less than or equal to the threshold Vth (no in ST220), the signal strength calculating unit 332 calculates a signal strength of the received target signal S by using the second calculation method based on the assumption that a noise signal whose frequency and amplitude are constant (as illustrated in FIG. 6A) is superimposed on the target signal S.

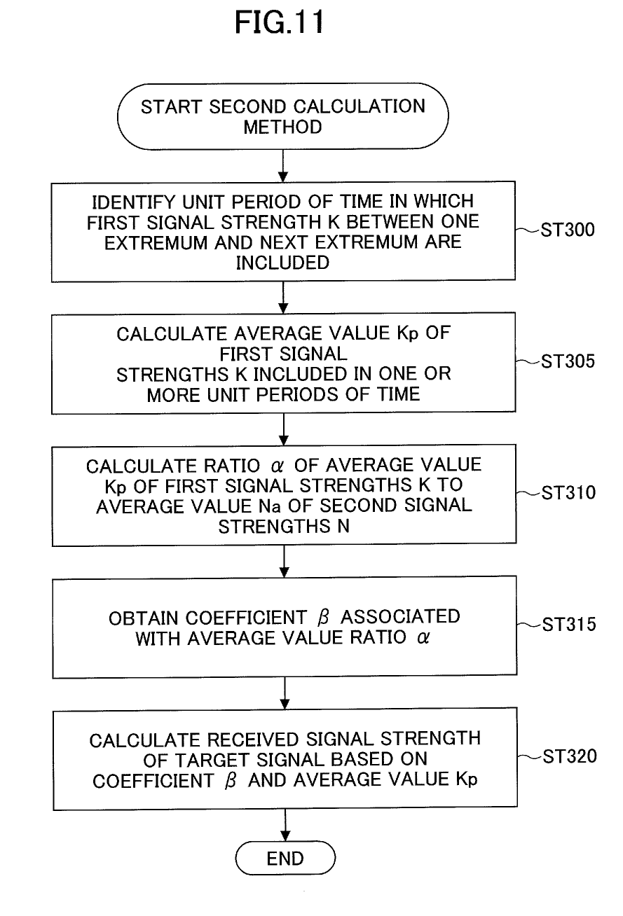

FIG. 11 is a flowchart illustrating an example of a process of the second calculation method.

In the second calculation method, the signal strength calculating unit 332 identifies one or more unit periods of time, in each of which first signal strengths K increase or decrease from one extremum to the next extremum (ST300). Next, the signal strength calculating unit 332 calculates an average value Kp of the first signal strengths K included in the one or more unit periods of time (ST305), and calculates a ratio a of the average value Kp of the first signal strengths K to the average value Na of the plurality of second signal strengths N (ST310). Based on the calculated average value ratio α, the signal strength calculating unit 332 obtains a coefficient β associated with the calculated average value ratio α (ST315). For example, by referring to the data table of the storage 34 in which coefficients β are each associated with a corresponding average value ratio α , the signal strength calculating unit 332 obtains a coefficient β associated with the average value ratio α. The signal strength calculating unit 332 calculates a signal strength of the received target signal S, by multiplying by the average value Kp of the first signal strengths K by the obtained coefficient β (ST320).

Referring back to FIG. 9, when it is determined that the variance value Vn of the plurality of second signal strengths N exceeds the threshold Vth (yes in ST220), the signal strength calculating unit 332 calculates the period of the plurality of second signal strengths N in order to determine periodicity with respect to changes in the amplitude of the noise signal (ST230). For example, the signal strength calculating unit 332 identifies a plurality of local maxima, with respect to second signal strengths N whose values are greater than or equal to the average value Na by a specified value or more. With respect to the identified plurality of local maxima, the signal strength calculating unit 332 calculates a time interval between one local maximum and the next local maximum as one period. Based on dispersion (such as a variance value) in the calculated periods of the second signal strength N, the signal strength calculating unit 332 determines whether changes in the second signal strengths N are periodic (ST235).

When the changes in the second signal strengths N are determined to be periodic (yes in ST235), the signal strength calculating unit 332 calculates a signal strength of the received target signal S by using the first process of the first calculation method based on the assumption that a noise signal whose amplitude changes periodically (as illustrated in FIG. 5C) is superimposed on the target signal (ST240). Conversely, when the changes in the second signal strengths N are determined to be non-periodic (no in ST235), the signal strength calculating unit 332 calculates a signal strength of the received target signal S by using the second process of the first calculation method based on the assumption that a noise signal whose amplitude changes non-periodically (as illustrated in FIG. 5E) is superimposed on the target signal (ST245).

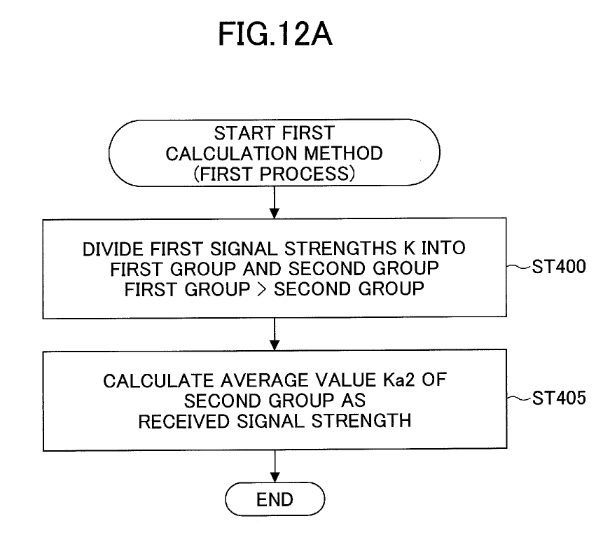

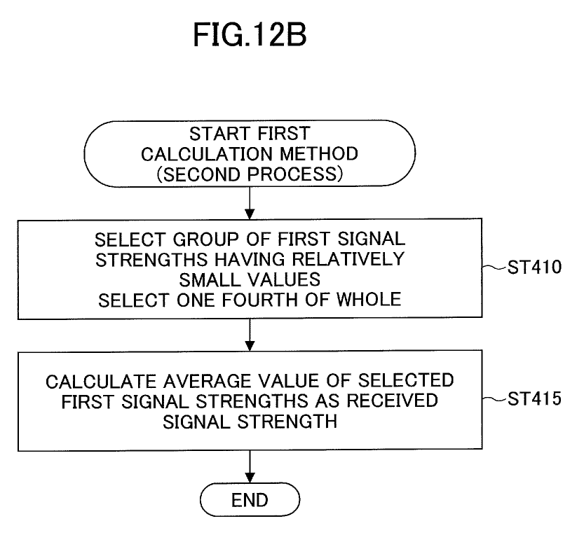

FIG. 12A is a diagram illustrating a flowchart of the first process of the first calculation method based on the assumption that a periodic noise signal (as illustrated in FIG. 5C) is superimposed on the target signal S. Also, FIG. 12A is an example of a process performed in step ST240 of the flowchart of FIG. 9.

In this case, the signal strength calculating unit 332 divides the plurality of first signal strengths K obtained over the first period of time TA into a first group of first signal strengths K that are relatively larger than a median value and a second group of first signal strengths K that are relatively smaller than the median value (ST400). The median value is determined based on a range of changes in the plurality of first signal strengths K. Of the two groups divided with the median value as the boundary, the signal strength calculating unit 332 calculates an average value Ka2 of the first signal strengths K of the second group as a signal strength of the received target signal S (ST405).

FIG. 12B is a diagram illustrating a flowchart of the second process of the first calculation method based on the assumption that a periodic noise signal whose amplitude changes non-periodically (as illustrated in FIG. 5E) is superimposed on the target signal S. Also, FIG. 12B is an example of a process performed in step ST245 of the flowchart of FIG. 9.

In this case, from the whole of the plurality of first signal strengths K obtained over the first period of time TA, the signal strength calculating unit 332 selects a group of first signal strengths K having relatively small values, which is equivalent to one-fourth of the whole (ST410). Then, the signal strength calculating unit 332 calculates an average value of the selected group of first signal strengths K as a signal strength of the received target signal S (ST415).

Referring back to FIG. 9, the signal strength calculating unit 332, when the average value Na of the plurality of second signal strengths N is determined not to exceed the threshold Nth (no in ST205), the signal strength calculating unit 332 causes the process to proceed to F1 illustrated in FIG. 10. More specifically, the signal strength calculating unit 332 divides the plurality of first signal strengths K obtained over the first period of time TA into a first group of first signal strengths K that are relatively larger than a median value and a second group of first signal strengths K that are relatively smaller than the median value (ST250). The median value is determined based on a range of changes in the plurality of first signal strengths K.

The signal strength calculating unit 332 calculates an average value Ka1 of the first group and an average value Ka2 of the second group (ST255). Then, the signal strength calculating unit 332 calculates a ratio R (=Ka1/Ka2) of the average value Ka1 to the average value Ka2 (ST260). The signal strength calculating unit 332 compares the average value ratio R to the threshold Rth (ST265).

When the average value ratio R is less than the threshold Rth (yes in ST265), the signal strength calculating unit 332 compares the average value Na of the plurality of second signal strengths N to the lower limit Nmin (ST270). When the average value Na is less than the lower limit Nmin (yes in ST270), the signal strength calculating unit 332 calculates, as a signal strength of the received target signal S, an average value Ka of the plurality of first signal strengths K obtained over the first period of time TA (ST275). When the average value Na is greater than or equal to the lower limit Nmin (no in ST270), the signal strength calculating unit 332 calculates a signal strength of the received target signal S by using the second calculation method (FIG. 11) based on the assumption that a noise signal whose frequency and amplitude are constant (as illustrated in FIG. 6A) is superimposed on the target signal S (ST280).

In step ST265, when the average value ratio R is determined to be greater than or equal to the threshold Rth (no in ST265), the signal strength calculating unit 332 calculates a first variance value V1 of the first signal strengths K of the first group, which are relatively larger than the median value, and also calculates a second variance value V2 of the first signal strengths K of the second group, which are relatively smaller than the median value (ST285). Then, the signal strength calculating unit 332 compares the first variance value V1 to the threshold Vth1, and also compares the second variance value V2 to the threshold Vth2 (ST290).

When the first variance value V1 exceeds a threshold Vth1 and also the second variance value V2 exceeds a threshold Vth2 (yes in ST290), this indicates that the overall amplitude of the first signal strengths K changes. Thus, the signal strength calculating unit 332 records, in the storage 34, unauthorized signal information indicating that an unauthorized signal (FIG. 6D) spoofing the target signal S has been transmitted over the first period of time TA (ST2110).

When the first variance value V1 is less than or equal to the threshold Vth1 or the second variance value V2 is less than or equal to the threshold Vth2 (no in ST290), the signal strength calculating unit 332 determines whether the first signal strengths K of the first group, which are relatively larger than the median value, and the first signal strengths K of the second group, which are relatively smaller than the median value, are distributed periodically (ST2100). For example, in the first period of time TA, the signal strength calculating unit 332 identifies periods of time, in each of which a predetermined number or more of first signal strengths K of the first group are continuously present, and obtains the length of each of the identified periods of time (or the sample number of first signal strengths K, which is equivalent to the length). When dispersion (a variance value, for example) in lengths of the identified periods of time is less than a predetermined value, the signal strength calculating unit 332 determines that the first group and the second group are periodically distributed in the first period of time TA.

When both the first group and the second group are determined to be periodically distributed in the first period of time TA (yes in ST2100), the signal strength calculating unit 332 calculates a signal strength of the received target signal S by using the first process of the first calculation method (FIG. 12A) based on the assumption that a periodic noise signal (as illustrated in FIG. 5C) is superimposed on the target signal S (ST2105). In the first period of time TA, when it is determined that the first signal strengths K of the first group and the first signal strengths K of the second group are not periodically distributed (no in ST2100), the signal strength calculating unit 332 records, in the storage 34, unauthorized signal information indicating that an unauthorized signal (FIG. 6D) spoofing the target signal S has been transmitted over the first period of time TA (ST2110).

According to the present embodiment, the following effects can be obtained.

The signal received over the second period of time TB, in which the target signal S is not transmitted from the vehicle-side device 2, is a noise signal other than the target signal S. The plurality of second signal strengths N is a plurality of signal strengths of the received noise signal. When the variance value Vn of the plurality of second signal strengths N exceeds the threshold Vth (yes in ST220 of FIG. 9), it is assumed that a noise signal superimposed on the target signal S is relatively large (as illustrated in FIG. 5C and FIG. 5E). In this case, according to the present embodiment, a signal strength of the received target signal S can be accurately calculated by using the first calculation method based on the assumption that a noise signal whose amplitude changes is superimposed on the target signal S (ST240 and ST245 of FIG. 9). Accordingly, even when a noise signal (as illustrated in FIG. 5C and FIG. 5E) whose amplitude changes is superimposed on the target signal S, a signal strength of the received target signal S can be accurately calculated.

According to the present embodiment, when the second signal strengths N change periodically (yes in ST235 of FIG. 9), a signal strength of the received target signal S can be accurately calculated by using the first process of the first calculation method based on the assumption that a noise signal (as illustrated in FIG. 50) whose amplitude changes periodically is superimposed on the target signal S (ST240 of FIG. 9). Further, when the second signal strengths N change non-periodically (no in ST235 of FIG. 9), a signal strength of the received target signal S can be relatively accurately calculated by using the second process of the first calculation method based on the assumption that a noise signal (as illustrated in FIG. 5E) whose amplitude changes non-periodically is superimposed on the target signal S (ST245 of FIG. 9).

According to the present embodiment, in the first process of the first calculation method (FIG. 12A), the plurality of first signal strengths K obtained over the first period of time TA are divided into a first group of first signal strengths K that are relatively larger than a median value and a second group of first signal strengths K that are relatively smaller than the median value (ST400 of FIG. 12A). The median value is determined based on a range of changes in the plurality of first signal strengths K. Then, an average value Ka2 of the first signal strengths K of the second group is calculated as a signal strength of the received target signal S according to the first process of the first calculation method (ST405 of FIG. 12A). When a noise signal is periodic (FIG. 5C), the possibility of the noise signal not being included in the first signal strengths K of the second group is high. Accordingly, a signal strength of the received target signal S can be accurately calculated by obtaining an average value of the first signal strengths of the second group.

According to the present embodiment, in the second process of the first calculation method (FIG. 12B), from the whole of the plurality of first signal strengths K obtained over the first period of time TA, a group of first signal strengths K having relatively small values, which is equivalent to a predetermined proportion to the whole, are selected (ST410 of FIG. 12B). Then, an average value of the selected group of first signal strengths K is calculated as a signal strength of the received target signal S according to the second process of first calculation method (ST415 of FIG. 12B). Even in the case of a non-periodic noise signal (FIG. 5E), the possibility of the noise signal not being included in the first signal strengths K having relatively small values is high. Accordingly, a signal strength of the received target signal S can be relatively accurately calculated by obtaining an average value of the first signal strengths K having relatively small values.

When the variance value Vn of the second signal strengths N is less than or equal to the threshold Vth (no in ST220 of FIG. 9), it is assumed that changes in the amplitude of the noise signal (as illustrated in FIG. 6A) superimposed on the target signal S are relatively small. In this case, according to the present embodiment, a signal strength of the received target signal S can be accurately calculated by using the second calculation method (FIG. 11) based on the assumption that a noise signal whose frequency and amplitude are constant is superimposed on the target signal S. Accordingly, even when changes in the amplitude of a noise signal superimposed on the target signal S are small, a signal strength of the received target signal S can be accurately calculated.

According to the present embodiment, when the average value Na of the plurality of second signal strengths N exceeds the threshold Nth, and also the variance value Vn of the second signal strengths N exceeds the threshold Vth, a signal strength of the received target signal S is calculated by using the first calculation method (ST240 and ST245 of FIG. 9). When the average value Na of the second signal strengths N exceeds the threshold Nth, and the variance value Vn of the second signal strengths N is less than or equal to the threshold Vth, a signal strength of the received target signal S is calculated by using the second calculation method (ST225 of FIG. 9). When the average value Na of the plurality of second signal strengths N exceeds the threshold Nth, a relatively large noise signal is superimposed on the target signal S. Accordingly, a signal strength of the received target signal S can be accurately calculated by using the first calculation method or the second calculation method.

According to the present embodiment, the plurality of first signal strengths K obtained over the first period of time TA are divided into a first group of first signal strengths K that are relatively larger than a median value and a second group of first signal strengths K that are relatively smaller than the median value (ST250 of FIG. 10). The median value is determined based on a range of changes in the plurality of first signal strengths K. Then, a first average value Ka1 of the first signal strengths K of the first group and also a second average value Ka2 of the first signal strengths K of the second group are calculated. Based on the ratio R of the first average value Ka1 to the second average value Ka2, it is determined whether changes in the first signal strengths K are large (ST265 of FIG. 10). When it is determined that the average value Na of the second signal strengths N is less than or equal to the threshold Nth (no in ST205 of FIG. 9), and that the changes in the first signal strengths K are small based on the average value ratio R (yes in ST265 of FIG. 10), a signal strength of the received target signal S is calculated by using the second calculation method (ST280 of FIG. 10).

Regardless of whether absolute values of the first signal strengths are large or small, the average value ratio R becomes closer to 1 as changes in the first signal strengths K become smaller, and the average value ratio R becomes farther from 1 as changes in the first signal strengths K become larger. Therefore, regardless of whether the absolute values of the first signal strengths K are large or small, it is possible to correctly determine whether changes in the first signal strengths K are relatively large based on the average value ratio R. When it is determined that the average value Na of the plurality of second signal strengths N is less than or equal to the threshold Nth, and that the changes in the first signal strengths K are small based on the average value ratio R, an absolute value of the amplitude of a noise signal superimposed on the target signal S is relatively small and changes in the amplitude are relatively small. In this case, a signal strength of the received target signal S can be more accurately calculated by using the second calculation method based on the assumption that a noise signal whose frequency and amplitude are constant (as illustrated in FIG. 6A) is superimposed on the target signal S (ST280 of FIG. 10).

According to the present embodiment, based on the first variance value V1 of the first signal strengths included in the first group, it is determined whether changes in the first signal strengths K of the first group are large. Also, based on the second variance value V2 of the first signal strengths included in the second group, it is determined whether changes in the first signal strengths K of the second group are large (ST290 of FIG. 10). When it is determined that the average value Na of the second signal strengths N is less than or equal to the threshold Nth (no in ST205 of FIG. 9), changes in the first signal strengths K are large based on the average value ratio R (no in ST265 of FIG. 10), and changes in the first signal strengths K of both of the first group and the second group are large (yes in ST290 of FIG. 10), unauthorized signal information indicating that an unauthorized signal spoofing the target signal S has been transmitted over the first period of time TA is recorded in the storage 34 (ST2110 of FIG. 10).

In a case where it is determined that the average value Na of the plurality of the second signal strengths N is less than or equal to the threshold Nth and changes in the plurality of first signal strengths K are large based on the average value ratio R, this indicates a situation where the changes in the plurality of first signal strengths K are large even though the absolute value of the amplitude of the noise signal is relatively small. This situation may happen when the absolute value of the amplitude of the target signal S is relatively small. However, in this situation, when it is determined that changes in first signal strengths K of the first group are large based on the first variance value V1, and also determined that changes in first signal strengths K of the second group are large based on the second variance value V2, there is a high possibility that the amplitude of the target signal S, which is supposed to be constant, may vary (as illustrated in FIG. 6D). In this case, according to the embodiment, unauthorized signal information is recorded in the storage 34. Accordingly, the use of an unauthorized signal for unlocking the doors is readily avoided.

According to the present embodiment, in a case where it is determined that the average value Na of the plurality of second signal strengths N is less than or equal to the threshold Nth (no in ST205 of ST205), changes in the first signal strengths K are large based on the average value ratio R (no in ST265 of FIG. 10), and changes in the first signal strengths K of one or both of the first group and the second group are small (no in ST290 of FIG. 10), unauthorized signal information indicating that an unauthorized signal spoofing the target signal S has been transmitted over the first period of time TA is recorded in the storage 34 (ST2110 of FIG. 10), in response to the first group and the second group being determined not to be periodically distributed (no in ST2100 of FIG. 10).

When it is determined that the average value Na of the plurality of second signal strengths N is less than or equal to the threshold Nth, changes in the first signal strengths K are large based on the average value ratio R, and changes in the first signal strengths K of one or both of the first group and the second group are small, this indicates a possibility that the absolute value of the amplitude of the target signal S may be relatively small and the noise signal may be periodic. However, when it is further determined that the first group and the second group are not distributed periodically, there is a high possibility that the amplitude of the target signal S, which is supposed to be constant, may vary (as illustrated in FIG. 6D). In this case, according to the embodiment, unauthorized signal information is recorded in the storage 34. Accordingly, the use of an unauthorized signal for unlocking the doors is readily avoided.

Although the embodiments of the present invention have been specifically described, the present invention is not limited to the above-described embodiments, and various variations and modifications may be made.

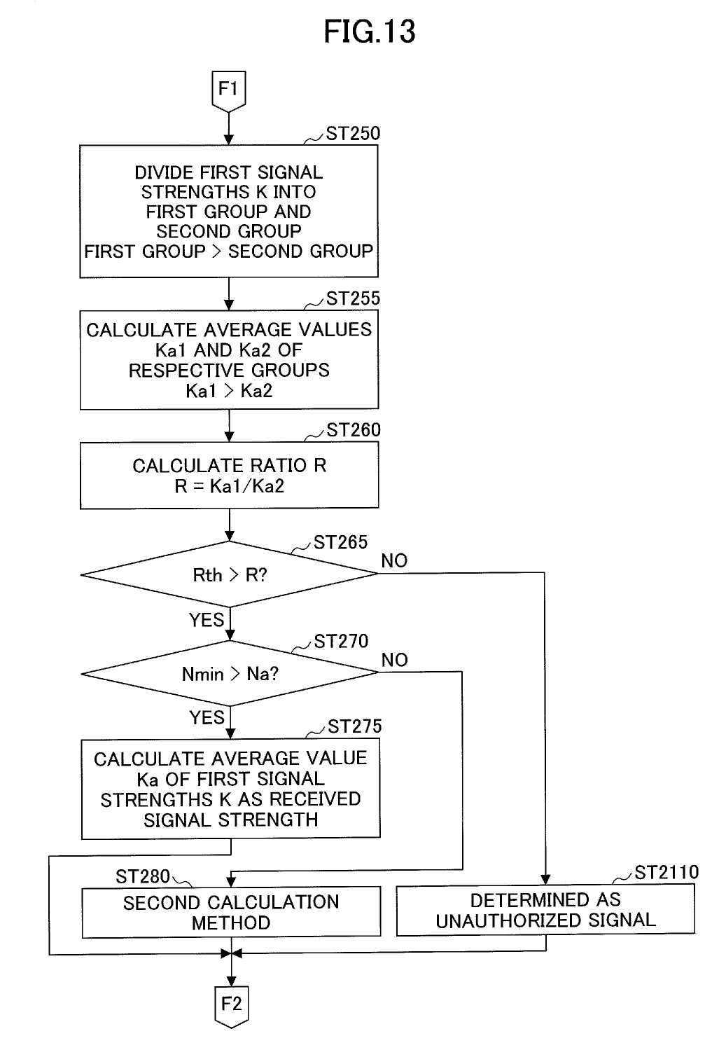

In the-above described embodiment, in order to determine whether an unauthorized signal spoofing the target signal S is transmitted, determination as to whether changes in the first signal strengths of the first group and of the second group are large (ST290 of FIG. 10), and also determination as to whether the distribution of the first group and the second group is periodic (ST2110 of FIG. 10) are performed. However, in a case where the threshold Nth used to determines whether the average value Na of the second signal strengths N is large or small is set to be relatively small, whether or not an unauthorized signal is transmitted may be determined by only determining whether changes in the first signal strengths K are large or small. For example, as illustrated in a flowchart in FIG. 13, when it is determined that changes in the first signal strengths K are large based on the average value ratio R (no in ST265), the process may directly proceed to ST2110, and unauthorized signal information may be stored in the storage 34.

In the-above described embodiment, an example in which the average value Na of second signal strengths N is compared to the threshold Nth in order to determine the magnitude of a noise signal is described; however, the present invention is not limited to this example. In other embodiments, the magnitude of a noise signal may be determined based on whether the maximum value of second signal strengths N obtained over the second period of time TB exceeds a predetermined value.

In the above-described embodiment, the signal strength calculating unit 332 of the portable device 3 calculates a signal strength of a received target signal S. However, in other embodiments, at least some functions of the signal strength calculating unit may be provided in the vehicle-side device.

Various aspects of the subject-matter described herein may be set out non-exhaustively below.

According to at least one embodiment, a received signal strength measuring apparatus for measurement of a signal strength of a received target signal is provided. The received signal strength measuring apparatus may include a receiver configured to receive one or more radio signals; a signal strength obtaining unit configured to obtain, as a plurality of first signal strengths, a plurality of received signal strengths at the receiver over a first period of time in which the target signal whose frequency and amplitude are constant is transmitted, and to obtain, as a plurality of second signal strengths, a plurality of received signal strengths at the receiver over a second period of time in which the target signal is not transmitted; and a signal strength calculating unit configured to calculate a signal strength of the received target signal, based on the plurality of first signal strengths obtained over the first period of time and on the plurality of second signal strengths obtained over the second period of time. The signal strength calculating unit is configured to calculate the signal strength of the received target signal by using a first calculation method when a variance value of the plurality of second signal strengths exceeds a first threshold, the first calculation method being based on an assumption that a noise signal whose amplitude changes is superimposed on the target signal, and calculate the signal strength of the received target signal by using a second calculation method when the variance value of the plurality of second signal strengths is less than or equal to the first threshold, the second calculation method being based on an assumption that a noise signal whose amplitude is constant is superimposed on the target signal.

According to the received signal strength measuring apparatus with the above-configuration, a signal transmitted over the second period of time, in which the target signal is not transmitted, is a noise signal. The plurality of second signal strengths is signal strengths of the received noise signal. When a variance value of the plurality of second signal strengths exceeds the first threshold, it is assumed that changes in the amplitude of the noise signal superimposed on the target signal are relatively large. In this case, the signal strength of the received target signal can be accurately calculated by using the first calculation method based on the assumption that a noise signal whose amplitude changes is superimposed on the target signal.

Conversely, when the variance value of the plurality of second signal strengths is less than or equal to the first threshold, it is assumed that changes in the amplitude of the noise signal superimposed on the target signal are relatively small. In this case, the signal strength of the received target signal can be accurately calculated by using the second calculation method based on the assumption that a noise signal whose amplitude is constant is superimposed on the target signal.

Preferably, the first calculation method may be divided into a first process and a second process. The first process is based on an assumption that a noise signal whose amplitude changes periodically is superimposed on the target signal and the second process is based on an assumption that a noise signal whose amplitude changes non-periodically is superimposed on the target signal. The signal strength calculating unit may determine whether the plurality of second signal strengths obtained over the second period of time change periodically, calculate the signal strength of the received target signal by using the first process when it is determined that the plurality of second signal strengths change periodically, and calculate the signal strength of the received target signal by using the second process when it is determined that the plurality of second signal strengths change non-periodically.

With this configuration, the plurality of second signal strengths is signal strengths of the received noise signal. Thus, when it is determined that the plurality of second signal strengths change periodically, the signal strength of the received target signal is more accurately calculated by using the first process based on the assumption that a noise signal whose amplitude changes periodically is superimposed on the target signal.

Conversely, when it is determined that the plurality of second signal strengths change non-periodically, the signal strength of the received target signal is more accurately calculated by using the second process based on an assumption that a noise signal whose amplitude changes non-periodically is superimposed on the target signal.

Preferably, in the first process of the first calculation method, the signal strength calculating unit may divide the plurality of first signal strengths obtained over the first period of time into a first group of first signal strengths that are relatively larger than a median value and a second group of first signal strengths that are relatively smaller than the median value, and calculate an average value of the first signal strengths of the second group as the signal strength of the received target signal, the median value being determined based on a range of changes in the plurality of first signal strengths.

When a noise signal is periodic, there may be a high possibility that the amplitude of the first group, which is relatively larger than the median value, may be increased due to the superimposed noise signal. Further, there may be a high possibility that the noise signal is superimposed on the second group, which is relatively smaller than the median value. Accordingly, when the noise signal whose amplitude changes periodically is superimposed on the target signal, a signal strength of the received target signal is more accurately calculated by obtaining the average value of the first signal strengths of the second group.

Preferably, in the second process of the first calculation method, from the whole of the plurality of first signal strengths obtained over the first period of time, the signal strength calculating unit may select a group of relatively smaller first signal strengths, which is equivalent to a predetermined proportion to the whole. Then, the signal strength calculating unit may calculate an average value of the group of the relatively smaller first signal strengths as the signal strength of the received target signal.

Even in the case of a non-periodic noise signal, there is a high possibility that the noise signal is not included in the first signal strengths having relatively small values. Thus, among the whole of the plurality of first signal strengths obtained over the first period of time, there is a relatively high possibility that the noise signal is not included in the group of relatively smaller first signal strengths, which is equivalent to a predetermined proportion to the whole. Accordingly, when the noise signal whose amplitude changes non-periodically is superimposed, a signal strength of the received target signal is more accurately calculated by obtaining the average value of the group of the relatively smaller first signal strengths.

Preferably, the signal strength calculating unit may calculate the signal strength of the received target signal by using the first calculation method, when an average value or a maximum value of the plurality of second signal strengths exceeds a second threshold and the variance value of the plurality of second signal strengths exceeds the first threshold, and may calculate the signal strength of the received target signal by using the second calculation method, when the average value or the maximum value of the plurality of second signal strengths exceeds the second threshold and the variance value of the plurality of second signal strengths is less than or equal to the first threshold.

With this configuration, when the average value or the maximum value of the plurality of second signal strengths exceeds the second threshold, a relatively high noise signal is superimposed on the target signal. Accordingly, a signal strength of the received target signal is more accurately calculated by using the first calculation method or the second calculation method.

Preferably, the signal strength calculating unit may divide the plurality of first signal strengths obtained over the first period of time into a first group of first signal strengths that are relatively larger than a median value and a second group of first signal strengths that are relatively smaller than the median value. The median value being determined based on a range of changes in the plurality of first signal strengths. Then, the signal strength calculating unit may determine whether changes in the plurality of first signal strengths are large, based on a ratio of a first average value of the first signal strengths of the first group to a second average value of the first signal strengths of the second group. the signal strength calculating unit may calculate the signal strength of the received target signal by using the second calculation method, in a case where it is determined that the average value or the maximum value of the plurality of second signal strengths is less than or equal to the second threshold and the changes in the plurality of first signal strengths are small based on the ratio of the average values.

With this configuration, regardless of whether absolute values of the first signal strengths are large or small, the average value ratio becomes closer to 1 as changes in the first signal strengths K become smaller, and the average value ratio becomes farther from 1 as changes in the first signal strengths become larger. Therefore, regardless of whether the absolute values of the first signal strengths are large or small, it is possible to correctly determine whether changes in the first signal strengths K are relatively large based on the average value ratio R.

In a case where it is determined that the average value or the maximum value of the plurality of second signal strengths is less than or equal to the second threshold and the changes in the plurality of first signal strengths are small based on the ratio of the average values, an absolute value of the amplitude of the noise signal is relatively small and changes in the amplitude of the target signal S are small. In this case, a signal strength of the received target signal is more accurately calculated by using the second calculation method based on the assumption that a noise signal whose frequency and amplitude are constant is superimposed on the target signal.

Preferably, the signal strength calculating unit may determine whether changes in the first signal strengths of the first group are large based on a first variance value of the first signal strengths of the first group. The signal strength calculating unit may determine whether changes in the first signal strengths of the second group are large based on a second variance value of the first signal strengths of the second group. The signal strength calculating unit may record information indicating that an unauthorized signal spoofing the target signal has been transmitted over the first period of time, in a case where it is determined that the average value or the maximum value of the plurality of second signal strengths is less than or equal to the second threshold, the changes in the plurality of first signal strengths are large based on the ratio of the average values, and the changes in the first signal strengths of both of the first group and the second group are large.

In a case where it is determined that the average value of the plurality of the second signal strengths N is less than or equal to the threshold Nth and changes in the plurality of first signal strengths are large based on the average value ratio R, this indicates a situation where the changes in the plurality of first signal strengths K are large even though the absolute value of the amplitude of the noise signal is relatively small. This situation may happen when the absolute value of the amplitude of the target signal is relatively small. However, in this situation, when it is determined that changes in first signal strengths K of the first group are large based on the first variance value, and also determined that changes in first signal strengths K of the second group are large based on the second variance value, there is a high possibility that the amplitude of the target signal, which is supposed to be constant, may vary. In this case, it is considered that an unauthorized signal spoofing the target signal has been transmitted over the first period of time, and information indicating the transmission of the unauthorized signal is recorded.

Preferably, the signal strength calculating unit may determine whether the first group and the second group are periodically distributed in the first period of time. The signal strength calculating unit may record the information indicating that the unauthorized signal spoofing the target signal has been transmitted over the first period of time, in a case where it is determined that the average value or the maximum value of the plurality of second signal strengths is less than or equal to the second threshold, the changes in the plurality of first signal strengths are large based on the ratio of the average values, the changes in the first signal strengths of one or both of the first group and the second group are small, and the first group and the second group are not periodically distributed.

When it is determined that the average value of the plurality of second signal strengths is less than or equal to the threshold, changes in the first signal strengths are large based on the average value ratio, and changes in the first signal strengths of one or both of the first group and the second group are small, this indicates a possibility that the absolute value of the amplitude of the target signal may be relatively small and the noise signal may be periodic. However, when it is further determined that the first group and the second group are not distributed periodically, there is a high possibility that the amplitude of the target signal, which is supposed to be constant, may vary. Accordingly, it is considered that an unauthorized signal spoofing the target signal has been transmitted over the first period of time, and information indicating the transmission of the unauthorized signal is recorded.

Preferably, the signal strength calculating unit may record information indicating that an unauthorized signal spoofing the target signal has been transmitted over the first period of time, in a case where it is determined that the average value or the maximum value of the plurality of second signal strengths is less than or equal to the second threshold and the changes in the plurality of first signal strengths are large based on the ratio of the average values.

When it is determined that the average value of the plurality of second signal strengths is less than or equal to the threshold and changes in the first signal strengths are large based on the average value ratio, this indicates a situation where the changes in the plurality of first signal strengths K are large even though the absolute value of the amplitude of the noise signal is relatively small. When a sufficiently small value is set as the second threshold, there is a high possibility that the amplitude of the target signal, which is supposed to be constant, may vary. Accordingly, it is considered that an unauthorized signal spoofing the target signal has been transmitted over the first period of time, and information indicating the transmission of the unauthorized signal is recorded.

Preferably, in the second calculation method, the signal strength calculating unit may calculate the signal strength of the received target signal based on a ratio of an average value of given first signal strengths within one or more unit periods of time to an average value of the plurality of second signal strengths obtained over the second period of time. The given first signal strengths increase or decrease from one extremum to a next extremum in each of the one or more unit periods of time.

In the second calculation method, it is assumed that signal strengths of a received combined signal, in which the target signal whose frequency and amplitude are constant is combined with the noise signal whose frequency and amplitude are constant, are equal to the first signal strengths. Further, it is assumed that signal strengths of the received noise signal whose frequency and amplitude are constant are equal to the second signal strengths. According to these assumptions, a frequency difference between the target signal and the noise signal would cause a change in the signal strength of the received combined signal as a beat. Further, a unit period of time, in which first signal strengths increase or decrease from one extremum to the next extremum, corresponds to a half-cycle of the beat. A ratio of an average value of the given first signal strengths within a period of time, in which one or more half-cycles of beats are combined, has a specific relationship with a ratio of the signal strengths of the received combined signal to the signal strength of the received target signal. Accordingly, based on the average value ratio, the signal strength of the received target signal is calculated.

According to at least one embodiment, a received signal strength measuring method for measuring a signal strength of a received target signal is provided. The received signal strength measuring method includes receiving one or more radio signals at a receiver; obtaining, as a plurality of first signal strengths, a plurality of received signal strengths at the receiver over a first period of time in which the target signal whose frequency and amplitude are constant is transmitted; obtaining, as a plurality of second signal strengths, a plurality of received signal strengths at the receiver over a second period of time in which the target signal is not transmitted; and calculating a signal strength of the received target signal, based on the plurality of first signal strengths obtained over the first period of time and on the plurality of second signal strengths obtained over the second period of time. The calculating includes calculating the signal strength of the received target signal by using a first calculation method when a variance value of the plurality of second signal strengths exceeds a first threshold, the first calculation method being based on an assumption that a noise signal whose amplitude changes is superimposed on the target signal, and calculating the signal strength of the received target signal by using a second calculation method when the variance value of the plurality of second signal strengths is less than or equal to the first threshold, the second calculation method being based on an assumption that a noise signal whose amplitude is constant is superimposed on the target signal.

Preferably, the first calculation method may be divided into a first process and a second process. The first process may be based on an assumption that a noise signal whose amplitude changes periodically is superimposed on the target signal, and the second process may be based on an assumption that a noise signal whose amplitude changes non-periodically is superimposed on the target signal. The calculating the received signal strength may further includes determining whether the plurality of second signal strengths obtained over the second period of time change periodically; calculating the signal strength of the received target signal by using the first method process when it is determined that the plurality of second signal strengths change periodically; and calculating the signal strength of the received target signal by using the second process when it is determined that the plurality of second signal strengths change non-periodically.

According to at least one embodiment, a non-transitory recording medium storing a program for causing a computer to execute the above-described received signal strength measuring method may be provided.

According to at least one embodiment, A keyless entry system includes a vehicle-side device configured to transmit the target signal whose frequency and amplitude are constant, and receive a response signal in response to the transmitted target signal; and a portable device configured to receive the target signal, and transmit the response signal. The portable device includes a received signal strength measuring unit configured to measure the signal strength of the received target signal, a distance calculating unit configured to calculate a distance from the vehicle-side device, based on the measured signal strength of the received target signal, and a transmitter configured to transmit the response signal, the response signal including information on the calculated distance. The received signal strength measuring unit is the above-described received signal strength measuring apparatus.

Further, the present invention is not limited to these embodiments, but various variations and modifications may be made without departing from the scope of the present invention.

What is claimed is

1. A received signal strength measuring apparatus for measurement of a signal strength of a received target signal, the received signal strength measuring apparatus comprising:
a receiver configured to receive one or more wireless signals;
a signal strength obtaining unit configured to obtain, as a plurality of first signal strengths, a plurality of received signal strengths at the receiver over a first period of time in which the target signal whose frequency and amplitude are constant is transmitted, and to obtain, as a plurality of second signal strengths, a plurality of received signal strengths at the receiver over a second period of time in which the target signal is not transmitted; and
a signal strength calculating unit configured to calculate a signal strength of the received target signal, based on the plurality of first signal strengths obtained over the first period of time and on the plurality of second signal strengths obtained over the second period of time,
wherein the signal strength calculating unit is configured to
calculate the signal strength of the received target signal by using a first calculation method when a variance value of the plurality of second signal strengths exceeds a first threshold, the first calculation method being based on an assumption that a noise signal whose amplitude changes is superimposed on the received target signal, and
calculate the signal strength of the received target signal by using a second calculation method when the variance value of the plurality of second signal strengths is less than or equal to the first threshold, the second calculation method being based on an assumption that a noise signal whose amplitude is constant is superimposed on the received target signal.

2. The received signal strength measuring apparatus according to claim 1, wherein the first calculation method is divided into a first process and a second process, the first process being based on an assumption that a noise signal whose amplitude changes periodically is superimposed on the received target signal and the second process being based on an assumption that a noise signal whose amplitude changes non-periodically is superimposed on the received target signal, and
wherein the signal strength calculating unit is configured to
determine whether the plurality of second signal strengths obtained over the second period of time change periodically,
calculate the signal strength of the received target signal by using the first process when it is determined that the plurality of second signal strengths change periodically, and
calculate the signal strength of the received target signal by using the second process when it is determined that the plurality of second signal strengths change non-periodically.

3. The received signal strength measuring apparatus according to claim 2, wherein, in the first process of the first calculation method, the signal strength calculating unit is configured to
divide the plurality of first signal strengths obtained over the first period of time into a first group of first signal strengths that are relatively larger than a median value and a second group of first signal strengths that are relatively smaller than the median value, the median value being determined based on a range of changes in the plurality of first signal strengths, and
calculate an average value of the first signal strengths of the second group as the signal strength of the received target signal.

4. The received signal strength measuring apparatus according to claim 2, wherein, in the second process of the first calculation method, the signal strength calculating unit is configured to
select a group of relatively smaller first signal strengths from a whole of the plurality of first signal strengths obtained over the first period of time, the group of the first signal strengths being equivalent to a predetermined proportion to the whole, and
calculate an average value of the group of the relatively smaller first signal strengths as the signal strength of the received target signal.

5. The received signal strength measuring apparatus according to claim 1, wherein the signal strength calculating unit is configured to
calculate the signal strength of the received target signal by using the first calculation method, when an average value or a maximum value of the plurality of second signal strengths exceeds a second threshold and the variance value of the plurality of second signal strengths exceeds the first threshold, and
calculate the signal strength of the received target signal by using the second calculation method, when the average value or the maximum value of the plurality of second signal strengths exceeds the second threshold and the variance value of the plurality of second signal strengths is less than or equal to the first threshold.

6. The received signal strength measuring apparatus according to claim 5, wherein the signal strength calculating unit is configured to
divide the plurality of first signal strengths obtained over the first period of time into a first group of first signal strengths that are relatively larger than a median value and a second group of first signal strengths that are relatively smaller than the median value, the median value being determined based on a range of changes in the plurality of first signal strengths,
determine whether changes in the plurality of first signal strengths are large, based on a ratio of a first average value of the first signal strengths of the first group to a second average value of the first signal strengths of the second group, and
calculate the signal strength of the received target signal by using the second calculation method, in a case where it is determined that the average value or the maximum value of the plurality of second signal strengths is less than or equal to the second threshold and the changes in the plurality of first signal strengths are small based on the ratio of the average values.

7. The received signal strength measuring apparatus according to claim 6, wherein the signal strength calculating unit is configured to
determine whether changes in the first signal strengths of the first group are large based on a first variance value of the first signal strengths of the first group, and
determine whether changes in the first signal strengths of the second group are large based on a second variance value of the first signal strengths of the second group, and
record information indicating that an unauthorized signal spoofing the target signal has been transmitted over the first period of time, in a case where it is determined that the average value or the maximum value of the plurality of second signal strengths is less than or equal to the second threshold, the changes in the plurality of first signal strengths are large based on the ratio of the average values, and the changes in the first signal strengths of both of the first group and the second group are large.

8. The received signal strength measuring apparatus according to claim 7, wherein the signal strength calculating unit is configured to
determine whether the first group and the second group are periodically distributed in the first period of time, and
record the information indicating that the unauthorized signal spoofing the target signal has been transmitted over the first period of time, in a case where it is determined that the average value or the maximum value of the plurality of second signal strengths is less than or equal to the second threshold, the changes in the plurality of first signal strengths are large based on the ratio of the average values, the changes in the first signal strengths of one or both of the first group and the second group are small, and the first group and the second group are not periodically distributed.

9. The received signal strength measuring apparatus according to claim 6, wherein the signal strength calculating unit is configured to record information indicating that an unauthorized signal spoofing the target signal has been transmitted over the first period of time, in a case where it is determined that the average value or the maximum value of the plurality of second signal strengths is less than or equal to the second threshold and the changes in the plurality of first signal strengths are large based on the ratio of the average values.

10. The received signal strength measuring apparatus according to claim 1, wherein, in the second calculation method, the signal strength calculating unit is configured to,
calculate the signal strength of the received target signal based on a ratio of an average value of given first signal strengths within one or more unit periods of time to an average value of the plurality of second signal strengths obtained over the second period of time, the given first signal strengths increasing or decreasing from one extremum to a next extremum in each of the one or more unit periods of time.

11. A received signal strength measuring method for measuring a signal strength of a received target signal, the received signal strength measuring method comprising:
receiving one or more wireless signals at a receiver;
obtaining, as a plurality of first signal strengths, a plurality of received signal strengths at the receiver over a first period of time in which the target signal whose frequency and amplitude are constant is transmitted;
obtaining, as a plurality of second signal strengths, a plurality of received signal strengths at the receiver over a second period of time in which the target signal is not transmitted; and
calculating a signal strength of the received target signal, based on the plurality of first signal strengths obtained over the first period of time and on the plurality of second signal strengths obtained over the second period of time,
wherein the calculating includes
calculating the signal strength of the received target signal by using a first calculation method when a variance value of the plurality of second signal strengths exceeds a first threshold, the first calculation method being based on an assumption that a noise signal whose amplitude changes is superimposed on the received target signal, and
calculating the signal strength of the received target signal by using a second calculation method when the variance value of the plurality of second signal strengths is less than or equal to the first threshold, the second calculation method being based on an assumption that a noise signal whose amplitude is constant is superimposed on the received target signal.

12. The received signal strength measuring method according to claim 11, wherein the first calculation method is divided into a first process and a second process, the first process being based on an assumption that a noise signal whose amplitude changes periodically is superimposed on the received target signal, and the second process being based on an assumption that a noise signal whose amplitude changes non-periodically is superimposed on the received target signal, and
wherein the calculating the signal strength of the received target signal further includes
determining whether the plurality of second signal strengths obtained over the second period of time change periodically;
calculating the signal strength of the received target signal by using the first process when it is determined that the plurality of second signal strengths change periodically; and
calculating the signal strength of the received target signal by using the second process when it is determined that the plurality of second signal strengths change non-periodically.

13. A non-transitory recording medium storing a program for causing a computer to execute the received signal strength measuring method according to claim 11.

14. A keyless entry system comprising:
a vehicle-side device configured to transmit the target signal whose frequency and amplitude are constant, and receive a response signal in response to the transmitted target signal; and
a portable device configured to receive the target signal, and transmit the response signal;
wherein the portable device includes
a received signal strength measuring unit configured to measure the signal strength of the received target signal,
a distance calculating unit configured to calculate a distance from the vehicle-side device, based on the measured signal strength of the received target signal, and
a transmitter configured to transmit the response signal, the response signal including information on the calculated distance, and
wherein the received signal strength measuring unit is the received signal strength measuring apparatus according to claim 1.
